(19) United States
(12) Patent Application Publication
(10) Pub. No.: US 2012/0125064 A1
(43) Pub. Date: May 24, 2012

(54) BIOCHAR COMPLEX

(76) Inventors: Stephen David Joseph, Saratoga (AU); Nikolaus Foidl, Graz (AT)

(21) Appl. No.: 13/320,523

(22) PCT Filed: May 7, 2010
(86) PCT No.: PCT/AU10/00534

§ 371 Date: Feb. 6, 2012

(30) Foreign Application Priority Data
May 15, 2009 (AU) 2009902209
Feb. 11, 2010 (AU) 2010900555

(51) Int. Cl. C05F 11/00; B01F 15/02; B32B 1/02; A01C 7/08; C05C 11/00; C05B 17/00

(52) U.S. Cl. 71/27; 71/11; 504/358; 504/299; 504/324; 504/292; 428/34.1; 111/100; 366/147; 425/471

(57) ABSTRACT

The invention relates to a biochar-containing composition comprising biochar having organic matter therein and/or thereon, clay associated, optionally intercalated, with the organic matter, a non-clay mineral and optionally also a plant growth promoter.

### TECHNICAL FIELD

The present invention relates to a composition comprising a biochar complex.

### BACKGROUND OF THE INVENTION

Biochar is a material produced by heating organic matter such as wood under low and/or excluded oxygen conditions. It consists principally of carbon, and commonly has channels, voids and pores. These are in some cases derived from corresponding structures in wood from which the biochar is made. As biochar is primarily carbon, it degrades very slowly (commonly over hundreds or even thousands of years). It has therefore been proposed as a vehicle for sequestering carbon in order to combat global warming caused by the build up of carbon dioxide in the atmosphere.

It has been found that application of biochar to soils can enhance the nutrient retention capacity and other properties of soils, and thereby improve crop yields. Biochar application to soil appears to have little effect on the carbon-nitrogen balance. Rather, it holds back water and nutrients so as to make them available to soil biota and growing plants.

The application rates to achieve substantial improvement are commonly very large, and specialised equipment is required in order to achieve significant improvement in yield. There is therefore little inducement for individuals or organisations to use biochar, as carbon credits are insufficiently valuable to compensate for the costs involved. There is therefore a need for a biochar-based composition, which can improve crop growth in quantities which are suitable for application using existing agricultural equipment. Such a composition would provide an additional economic benefit beyond the carbon credits for use of biochar.

Amazonian natives have long produced fertile soils called Terra Preta (“dark earth”), effectively using a form of biochar in combination with heated organic matter, ash and ceramic materials. Several variations to this were also used. Terra Preta however was made using highly variable raw materials and required many years of continuous addition of these materials to make. It would be of great benefit to agriculture to produce a fertilising and/or growth promoting material similar to Terra Preta, preferably With improved fertilising and/or growth promoting capacity, and to provide a rapid and inexpensive process for making it.

### OBJECT OF THE INVENTION

It is the object of the present invention to substantially overcome or at least ameliorate one or more of the above disadvantages.

### SUMMARY OF THE INVENTION

In a broad form, the invention provides a biochar-containing composition comprising biochar, clay, minerals (e.g. non-clay minerals), organic matter and at least one plant growth promoter (such as auxofuran or butenolide). The biochar-containing compositions of the invention may be bio-char containing complexes. The organic matter may be proteinaceous or may be derived from proteinaceous matter. It may contain polysaccharides or may be derived from polysaccharides and/or oligosaccharides and/or monosaccharides. The at least one plant growth promoter may be selected from the group consisting of nitrogen containing polymers, biopolymers and small molecule oxygen and/or nitrogen functional growth promoters. The minerals may be selected from the group consisting of dolomite, rock phosphate, calcium, potassium and magnesium as their sulphate, chloride, oxide, hydroxide or carbonate salts, titanium containing minerals (e.g. rutile and ilmenite), sand, silica, silicates and rare earth metals and sulphate, oxide, hydroxide or carbonate salts thereof.

In a first aspect of the invention there is provided a biochar-containing composition (or complex) comprising:
biochar having organic matter therein and/or thereon;
clay intercalated with the organic matter;
at least one non-clay mineral; and
at least one plant growth promoter.

In a variation of the first aspect there is provided a biochar-containing composition (or complex) comprising:
biochar having organic matter therein and/or thereon;
clay associated with the organic matter;
at least one non-clay mineral; and
optionally at least one plant growth promoter.

The clay may be associated with the organic matter by being at least partially intercalated (as described in the first aspect above) and/or the clay may be at least partially exfoliated. The organic matter may be precipitated on the clay platelets. It may be electrostatically bonded, or electrostatically bound, to the clay platelets.

The organic matter may be compost, manure, sludges, paper mill waste, biosolids and green waste or any combination thereof.

In another variation of the first aspect of the invention there is provided a biochar-containing composition comprising:
biochar having organic matter therein and/or thereon;
clay intercalated with the organic matter; and
at least one non-clay mineral.

The following options may be used in combination with the first aspect (including either of the variations described above), either individually or in any suitable combination.

The at least one plant growth promoter may be selected from the group consisting of nitrogen containing polymers, biopolymers and small molecule oxygen and/or nitrogen functional growth promoters. The nitrogen containing polymer may be a urea-formaldehyde polymer. Thus the composition may comprise a nitrogen containing polymer. It may comprise a butenolide or auxofuran. It may comprise salicylic acid. It may comprise chitin and/or chitosan. It may comprise a jasmonate. The at least one plant growth promoter may represent about 1 to about 20% by weight of the composition. It (they) may in combination represent about 1 to 10, 1 to 5, 5 to 20, 10 to 20 or 5 to 10%, e.g. about 1, 2, 3, 4, 5, 6, 7, 8, 9, 10, 15 or 20% by weight of the solids of the composition.

The at least one non-clay mineral may be selected from the group consisting of dolomite, rock phosphate, calcium, potassium and magnesium as their sulphate, chloride, oxide, hydroxide or carbonate salts, titanium containing minerals (e.g. rutile and ilmenite), sand, silica, silicates and rare earth metals and sulphate, oxide, hydroxide or carbonate salts thereof. Either the biochar or the clay or both may be at least partially intercalated with the at least one non-clay mineral. They may be associated therewith in some other fashion. They may be associated with at least partially exfoliated clay platelets. They may be associated by electrostatic bonding or in some other manner. In the event that more than one of the minerals is present, either the biochar or the clay or both may be intercalated with at least one of said non-clay minerals.

The biochar may be at least partially derived from wood and/or green matter such as green waste or garden clippings. It may be derived from a substance that is at least partially cellulosic. It may be surface oxidised. It may be electroplated. It may be surface coated with one or more metal sulphates, chlorides or hydroxides.

The organic matter may be proteinaceous or may be derived from proteinaceous matter. The organic matter may contain polysaccharides or may be derived from polysaccharides and/or oligosaccharides and/or monosaccharides. It may comprise waste material. It may comprise animal derived waste and/or insect derived waste and/or bacterial derived waste and/or fungal derived waste and/or plant derived waste. In some instances the organic matter is toxic to plants. Such toxic matter includes for example some composts. This may for example be the case for certain compost materials. This may be overcome by treating the organic matter with an acid. The acid may be an organic acid or it may be a mineral acid. It may be a phosphorus containing acid. It may be for example sulphuric acid or nitric acid or phosphoric acid or phosphorous acid. It is preferably not a halogenated acid such as hydrochloric acid. It may be an acid that does not contain a halogen. The acid may be used at a concentration of about 5 to about 20% by weight, e.g. about 10%. The acid may be added in sufficient quantity to approximately neutralise the organic matter. It may be added in sufficient quantity to bring the pH of the organic matter to about 6.5 to about 7. The organic matter may be acid treated organic matter. It may be organic matter having a pH of about 6.5 to about 7. It may be organic matter at approximately neutral or slightly acid pH.

The composition may additionally comprise additional minerals other than clay. These may for example include rare earths, calcium, magnesium, manganese, iron phosphorus, potassium etc. present as their sulphate, chloride carbonate, oxide or hydroxide state and/or titanium containing minerals (e.g. rutile and ilmenite), sand, silica, silicates etc. The clay may be associated, e.g. intercalated or otherwise associated, with these non-clay minerals.

The composition may be in the form of particles. At least some of the particles may have a structure in which the biochar is surrounded by a layer of particles of the clay. The composition may be in the form of granules, pellets, prills etc. These may represent aggregates of the particles. The composition may be in the form of a slurry, commonly a slurry of the particles. It may be in the form of a dry powder or of a dry granular or particulate substance.

In an embodiment of the invention there is provided a biochar-containing composition comprising:
biochar having organic matter therein and/or thereon, said organic matter being selected from the group consisting of proteinaceous matter, mono- oligo- and polysaccharides and matter derived from any one or more of these;
clay intercalated with the organic matter selected from the group consisting of proteinaceous matter, mono- oligo- and polysaccharides and matter derived from any one or more of these,
at least one non-clay mineral; and
a nitrogen containing polymer, a butenolide, salicylic acid and chitin and/or chitosan.

In another embodiment of the invention there is provided a biochar-containing composition comprising:
biochar having organic matter therein and/or thereon, said organic matter being selected from the group consisting of proteinaceous matter, mono- oligo- and polysaccharides and matter derived from any one or more of these;
clay intercalated with the organic matter selected from the group consisting of proteinaceous matter, mono- oligo- and polysaccharides and matter derived from any one or more of these,
at least one non-clay mineral selected from the group consisting of dolomite, rock phosphate, calcium, potassium, manganese and magnesium as their sulphate, chloride, oxide, hydroxide or carbonate salts and rare earth metals and sulphate, oxide, hydroxide or carbonate salts thereof; and
a nitrogen containing polymer, a butenolide, salicylic acid and chitin and/or chitosan,
   said composition being in the form of particles, at least some of which have a structure in which the biochar is surrounded by a layer of the clay, and said particles being aggregated into granules.

In a second aspect of the invention there is provided a process for making a biochar-containing composition, said process comprising:
(i) combining organic matter, one or more non-clay minerals, biochar and a swelling clay and mixing in a mixing vessel at a sufficient temperature for pillaring of the clay, so as to form a pillared mixture;
(ii) torrefying the pillared mixture in a torrefier so as to form a torrefied product and an exhaust gas, wherein a heated gas is injected into the torrefier during said torrefying; and
(iii) cooling the torrefied mixture, e.g. to about ambient temperature (e.g. to about 15 to about 30° C.) and combining the cooled torrefied mixture with at least one plant growth promoter to form the composition.

The term “torrefying” refers to a heat treatment. It is commonly conducted at about 100 to about 290° C. or about 120 to about 290° C. A preferred temperature range for the present invention is between about 150 to about 240° C., or about 150 to about 250° C. or about 160 to about 240° C. It may for example be conducted at about 180° C. The term “pillar” refers to a process that intercalates organic matter and/or minerals between aluminium oxide and silicon oxide layers of the clay, and is commonly conducted at moderately elevated temperature.

The following options may be used in combination with the second aspect, either individually or in any suitable combination.

The biochar may have been electroplated prior to step (i).

The process may comprise using the exhaust gas to heat the mixing vessel. Commonly the exhaust gas will contain smoke chemicals generated or released during the torrefying. In using the exhaust gas to heat the mixing vessel, an aqueous liquid containing the smoke chemicals may be condensed from the exhaust gas. The exhaust gas may comprise a vapour, for example steam. The condensed aqueous liquid may be combined with the torrefied mixture and at least one plant growth promoter so as to form the composition in the form of a slurry. Alternatively or additionally, a separate concentrate of smoke chemicals may be prepared and used in making the slurry. The process may additionally comprise drying and compacting, densifying and/or agglomerating (e.g. pelletising, granulating etc.) the slurry so as to form the composition in the form of granules, pellets, prills or some other suitable form.

The heated gas may be obtained from preparation of the biochar. It may be obtained from some other source, e.g. pyrolysis, low temperature combustion etc. of a suitable feedstock.

The sufficient temperature of step (i) may be about 50 to about 100° C., commonly about 80° C. Step (ii) may be conducted at about 100 to about 290° C., or about 120 to about 290° C. or at about 150 to about 240 ° C. or about 150 to about 250 ° C. or about 160 to about 240 ° C., or at about 110 to about 230° C.

The process may comprise chemically oxidising the surface of the biochar prior to step (i). It may comprise chemically oxidising the surface of the biochar after step (i). It may comprise electroplating or electrocoating the surface of the biochar prior to step (i). The electroplating may deposit a metal out of a salt or other compound or complex thereof on the surface of the biochar. The metal is preferably in ionic form in the electrolyte so that the metal may be added as a salt which dissolves in its ions and then is transported to the surface of the biochar by means of the electrical field/current. Alternatively the surface of the biochar may serve as a condensation or crystallization point for the metal or a salt or complex thereof. The metal may be selected from the group consisting iron, manganese, copper, magnesium, calcium and potassium and the salt may be for example an oxide or a hydroxide, sulphate, chloride or carbonate of any one or more of these.

In an embodiment of the invention there is provided a process for making a biochar-containing composition, said process comprising:
(i) combining organic matter, biochar, one or more non-clay minerals, and a swelling clay and mixing in a mixing vessel at about 80° C., so as to form a pillared mixture;
(ii) torrefying the pillared mixture in a torrefier at about 200 to about 240° C. so as to form a torrefied product and an exhaust gas, wherein a heated gas obtained from preparation of the biochar is injected into the torrefier during said torrefying;
(iii) using the exhaust gas to heat the mixing vessel, thereby condensing an aqueous liquid containing smoke chemicals from the exhaust gas; and
(iv) combining the torrefied mixture with a nitrogen containing polymer, a butenolide, salicylic acid, chitin and/or chitosan and the aqueous liquid containing smoke chemicals to form the composition.

In another embodiment of the invention there is provided a process for making a biochar-containing composition, said process comprising:
(i) combining organic matter, biochar, one or more non-clay minerals, and a swelling clay and mixing in a mixing vessel at about 80° C., so as to form a pillared mixture;
(ii) torrefying the pillared mixture in a torrefier at about 200 to about 240° C. so as to form a torrefied product and an exhaust gas, wherein a heated gas obtained from preparation of the biochar is injected into the torrefier during said torrefying;
(iii) using the exhaust gas to heat the mixing vessel, thereby condensing an aqueous liquid containing smoke chemicals from the exhaust gas;
(iv) combining the torrefied mixture with a nitrogen containing polymer, a butenolide, salicylic acid, chitin and/or chitosan and the aqueous liquid containing smoke chemicals to form the composition in the form of a slurry; and
(v) drying and pelletising the slurry so as to form the composition in the form of granules.

The invention also provides a biochar composition obtainable by, or obtained, by the process of the second aspect. The composition may comprise biochar, clay, minerals (e.g. non-clay minerals), organic matter and at least one plant growth promoter. It may comprise biochar having organic matter therein and/or thereon, clay intercalated with organic matter, at least one non-clay mineral and at least one plant growth promoter.

In a third aspect of the invention there is provided a method for planting a crop comprising seeds in a soil comprising inserting said seeds into the soil and locating a composition according to the first aspect of the invention into said soil and/or onto and/or near to said seeds.

The locating may be onto the seeds. It may be near the seeds. It may be both onto and near the seeds. It may be near, but not in contact with, the seeds. It may be around the seeds. The locating may be conducted concurrently with the inserting or it may be conducted before the inserting or it may be conducted after the inserting. The method may be conducted using existing mechanised planting equipment. The composition may be located in the soil in the form of a slurry. It may be located in the soil in the form of granules.

In a variation of the third aspect of the invention there is provided a method for planting a crop comprising juvenile plants in a soil comprising inserting said juvenile plants into the soil and locating a composition according to the first aspect of the invention into said soil and/or onto and/or near to said juvenile plants.

In a further variation of the third aspect of the invention there is provided a method for planting a crop comprising sedlings in a soil comprising inserting said seedlings into the soil and locating a composition according to the first aspect of the invention into said soil and/or onto and/or near to said seedlings.

In another variation of the third aspect of the invention there is provided a method for planting a crop comprising seeds, seedlings and/or juvenile plants in a soil comprising inserting said seeds, seedlings and/or said juvenile plants into the soil and locating a composition according to the first aspect of the invention into said soil and/or onto and/or near to said seeds, seedlings and/or said juvenile plants.

In a variation of the third aspect of the invention there is provided a method for planting a crop in a soil comprising plants comprising inserting said plants into the soil and locating a composition according to the first aspect of the invention into said soil and/or onto and/or near to said plants.

In a variation of the third aspect of the invention there is provided a method for planting a crop in a soil comprising mature plants comprising inserting said mature plants into the soil and locating a composition according to the first aspect of the invention into said soil and/or onto and/or near to said mature plants.

In another aspect of the invention there is provided a method for fertilising a crop in a soil comprising locating a composition according to the first aspect of the invention into said soil and/or onto and/or near to said crop. The crop may comprise plants. The crop may comprise seeds, seedlings, juvenile plants or mature plants or any combination thereof.

The application rate of the composition according to the first aspect of the invention into said soil and/or onto and/or near to said plantss may be an amount effective to at least partially fertilise the plants. The application rate of the composition according to the first aspect of the invention into said soil and/or onto and/or near to said seeds and/or seedlings and/or juvenile plants and/or mature plants may be an amount effective to at least partially fertilise the seeds, seedlings, juvenile plants and/or mature plants. The composition according to the first aspect of the invention may at least partially replace traditional chemical fertilisers such as phosphates. The application rate will depend on various factors including the quality of the soil and the nature of the crop. For example, a poor soil may require a lower application rate of the composition of the first aspect of the invention than that required for a good quality soil in order to effect an improvement in the yield in the ultimate crop. The composition of the first aspect of the invention may build up in the soil after several applications over several seasons and may gradually build-up the carbon content of the soil.

The third aspect, together with any of the variations described above, may also comprise the step of applying a nitrogen based fertiliser (e.g. an ammonia based fertilisier) to said soil at or proximate the location where the composition is to be located prior to the step of locating the composition. The method may additionally comprise waiting for a period of time between applying the fertiliser and applying the composition. The period of time may be about 1 week to about 3 months, or about 1 to about 2 months.

In a another variation of the third aspect there is provided a method for planting a crop in a soil comprising applying a composition according to the first aspect of the invention to said soil, and planting plants of said crop in the soil proximate the soil to which the composition was applied. In a further variation of the third aspect there is provided a method for planting a crop in a soil comprising applying a composition according to the first aspect of the invention to said soil, and planting seeds, seedlings, juvenile plants and/or mature plants of said crop in the soil proximate the soil to which the composition was applied. The method may additionally comprise waiting for a period of time between said applying and said planting. The period of time may be about 1 week to about 3 months, or about 1 to about 2 months.

In another variation of the third aspect there is provided a method for planting a crop comprising at least one plant in a soil comprising planting one or more of said plants in soil which is disposed in a pot, said pot being constructed using, or comprising, a composition according to the first aspect of the invention.

In yet a further variation of the third aspect there is provided a method for planting a crop in a soil comprising planting one or more seeds, seedlings, juvenile plants and/or mature plants of said crop in soil which is disposed in a pot, said pot being constructed using, or comprising, a composition according to the first aspect of the invention.

The composition, optionally in the form of a slurry, may be formed into a pot by means of pressure and/or mild heating and/or drying. The resultant pot is capable of releasing nutrients to a growing plant so as to promote improved growth of the plant. In this variation, the pot may be on, or at least partially inserted into, the ground or into a larger body of soil. In operation of the method, roots of the growing plant may penetrate the pot to reach soil outside the pot.

In a fourth aspect of the invention there is provided an apparatus for making a biochar composition, said apparatus comprising:
a mixer for mixing starting materials at mildly elevated temperatures,
a torrefier for torrefying a pillared mixture produced in the mixer,
a post-mixer for combining a torrefied product from the torrefier with additives, and
a transfer device for transferring the mixture from the mixer to the torrefier,
   wherein the torrefier comprises at least one hot gas inlet port for passing a hot gas into the torrefier so as to heat contents of the torrefier in use.

The following options may be used in conjunction with the fourth aspect, either individually or in any suitable combination.

The apparatus may comprise a biochar furnace for producing biochar for use in the mixer. The furnace may comprise an exhaust outlet coupled to the at least one hot gas inlet port of the torrefier so as to convey hot gases from the furnace to the torrefier in use.

The mixer may comprise a heating jacket at least partially surrounding a mixing vessel for heating contents of the mixing vessel. The torrefier may comprise a torrefier gas outlet in gas communication with said heating jacket. In use, heated gas from the torrefier may pass out of the torrefier gas outlet and into the heating jacket. The heating jacket may comprise a drain line coupled to the post-mixer whereby in use, condensate from the heated gas from the torrefier is conveyed to the post-mixer and combined with the torrefied product therein.

The apparatus may additionally comprise a device for compacting, densifying, agglomerating, granulating or pelletising the biochar composition, e.g. a pelletiser or granulator, coupled to an outlet from the post-mixer for producing granules of the biochar composition from a mixture of the torrefied product and the additives. The pelletiser may comprise a dryer for drying the mixture before or during formation of the granules.

The apparatus may comprise a mould for forming a shape from the biochar composition. The apparatus may additionally comprise a low temperature firing kiln for firing the shaped composition so as to form a solid shape of said composition. The low temperature firing kiln may be capable of firing the composition at a temperature of about 250 to about 350° C., or about 290 to 300° C.

### BRIEF DESCRIPTION OF THE DRAWINGS

A preferred embodiment of the present invention will now be described, by way of an example only, with reference to the accompanying drawings wherein:

FIG. 1 is a diagram illustrating the process for making the composition of the invention;

FIG. 2 is a flowchart for making the composition;

FIG. 3 shows a simplified flowchart for making the composition;

FIG. 4 is a graph showing comparing the Mean Total Yield (t/ha) of Bruce Rock wheat crops in response to different combinations of fertiliser;

FIG. 5 shows a biochar surrounded by a clay mineral layer;

FIG. 6 shows a torrefied wood particle with a high concentration of Al, Si, P, K, Ca and Fe around one of the pores;

FIG. 7 shows torrefied chicken manure with a range of minerals on the surface;

FIG. 8 shows biochar oxidised with acid and coated with clay and minerals to give a high surface area and high cation exchange;

FIG. 9 shows a TEM (transition electron microscope) micrograph of the microstructure of BMC (biochar mineral complex);

FIG. 9a shows a TEM micrograph of a portion of a BMC;

FIGS. 9b to 9i show EDX (energy dispersive X-ray spectroscopy) traces of 8 points marked 1 to 8 respectively on the micrograph of FIG. 9a so as to provide a quantitative analysis of the different minerals, the carbon and oxygen content at the micron level on a specific surface section;

FIG. 10 is a series of elemental maps showing the internal structure of a BMC;

FIG. 11 shows the internal distribution of elements from a microprobe;

FIG. 12 shows the internal distribution of elements of wood biochar;

FIG. 13 shows a test program for producing a biochar-containing composition according to the present invention;

FIG. 14 is a schematic diagram of a 3 tonne/hour plant layout;

FIG. 15 shows the results of surface characterisation by XPS (X-ray photoelectron spectroscopy) of the surface elements and compounds of a BMC;

FIG. 16 shows the results of surface characterisation by XPS of a second BMC;

FIG. 17 is an FTIR (Fourier transform infrared spectroscopy) spectrum of BMC 5;

FIG. 18 is an FTIR spectrum of BMC 6;

FIG. 19 is a graph of solubility of five BMCs;

FIG. 20 is a graph of the pH of the soil around BMC particles as a function of time;

FIG. 21 shows a liquid chromatography analysis of biochar in water;

FIG. 22 is a series of NMR (nuclear magnetic resonance) spectra of a BMC compares to that of charcoal;

FIG. 23 shows TG-MS (thermogravimetry-mass spectroscopy) results;

FIG. 24 shows TG-MS results;

FIG. 25 shows TG-MS results;

FIG. 26 shows TG-MS results;

FIG. 27 are photographs of trials of use of BMC on sorghum and sunflowers;

FIG. 28 is a graph showing the grain yield per bin for rates of the different fertilisers applied to sorghum;

FIG. 29 is a graph showing the relationship between grain yield and total applied phosphorus at sowing for the different fertiliser treatments;

FIG. 30 shows the results of trials of use of BMC on wheat;

FIG. 31 shows the result of wheat pot trials;

FIG. 32 shows the height of the wheat plants as a function of the rate of application of biochar;

FIG. 33 shows an agglomerate particle attached to the roots of a plant;

FIG. 34 are results showing an improvement in phosphorus use;

FIG. 35 are results showing an improvement in fungi growth;

FIG. 36 shows a biochar mineral complex plant; and

FIG. 37 shows crop data using the biochar mineral complex.

### DETAILED DESCRIPTION OF THE PREFERRED EMBODIMENTS

The biochar-containing composition of the present invention provides a number of environmental benefits:
1) biochar sequesters carbon dioxide that would otherwise be released into the atmosphere. Use of biochar in the present invention therefore serves to combat global warming.
2) the composition commonly uses waste matter, e.g. waste fecal matter, which would otherwise represent a pollutant.
3) the composition encourages plant growth. In some cases this may also increase sequestering of carbon into those plants (depending on the fate of the grown plants).
4) by encouraging plant growth, it reduces the need for artificial fertilisers which are known pollutants.
   Additionally, the process for making the composition may be adapted to utilise waste heat and waste products where possible in order to reduce the environmental footprint of the process. Waste heat may be used for sterilising soil, for heating soil so as to extend the growing season of plants in the soil, for killing pathogens, for aquaculture etc. By providing an economically useful product, the process encourages use of that product and therefore encourages sequestering of carbon dioxide. The process may be net carbon negative. Use of the composition of the invention may reduce the use of pesticides and/or herbicides while maintaining or increasing crop yield and/or quality. This may in itself be an environmental benefit, and may also contribute to reducing the carbon footprint of agricultural processes using the composition.

In the process for making the composition of the invention, organic matter, biochar, non-clay minerals and a swelling clay are combined and mixed in a mixing vessel at a suitable temperature for pillaring of the clay. Pillaring is a process in which the clay is intercalated with the organic matter. The swelling clays used in the process comprise, at least in part, a plurality of platelets which in the native state of the clay are aligned parallel to each other. During swelling and pillaring, substances are interposed between the platelets to form a pillared clay. This process may be facilitated by the use of heat and the presence of water. Thus the mixture commonly is initially in the form of an aqueous slurry of the above mentioned components. During the mixing and pillaring, air or some other suitable gas is commonly injected into the mixing vessel. This serves to remove unneeded water by evaporation, and may also contribute to the mixing. The mixing is commonly at a temperature of about 50 to about 100° C., optionally 50 to 70, 70 to 100 or 70 to 90° C., for example about 50, 60, 70, 80, 90 or 100° C. The time required may be about 1 to about 8 hours, or about 2 to about 8 hours, or about 1 to 5, 2 to 5, 5 to 8 or 3 to 6 hours, e.g. about 2, 3, 4, 5, 6, 7 or 8 hours. Typical conditions are about 5 hours at about 80° C.

Components used in making the pillared mixture include:

Biochar—this is primarily carbon, and may additionally comprise hydrogen, oxygen and various minerals, and is derived from biomass, which may be waste biomass. Suitable biomass for making biochar includes agricultural residues (e.g. crop residues, corn stover, rice or peanut hulls etc.), animal manures, industrial wastes (e.g. paper mill sludge, residues from sugar mills and other organic derived by-products of industrial processes), wood products (timber, timber pulp, wood chips, tree bark). Thus heating of the biomass under low or zero oxygen conditions can produce biochar together with bio energy. The heating is commonly at a temperature of about 290 to about 800° C., or about 300 to 800, 400 to 800, 600 to 800, 290 to 600, 290 to 400, 300 to 600, 300 to 450, 450 to 600 or 350 to 550° C., e.g. about 290, 300, 350, 400, 450, 500, 550, 600, 650, 700, 750 or 800° C. Thus while an initial energy input is required in order to raise the biomass to a suitable temperature for formation of biochar, once at temperature the conversion of organic matter to biochar may provide excess energy, which may be used elsewhere. The resulting bioenergy may be for example in the form of a heated gas or a flammable gas. This may comprise carbon dioxide, carbon monoxide, nitrogen containing species or combinations of these. It may be generated at a temperature of about 300 to about 800° C., or about 350 to 800, 400 to 800, 600 to 800, 290 to 600, 290 to 400, 300 to 600, 300 to 450, 450 to 600 or 350 to 550° C., e.g. about 300, 350, 400, 450, 500, 550, 600, 650, 700, 750 or 800° C. The biochar is commonly a fine-grained, porous charcoal substance. It may have pores/channels derived from phloem and xylem of wood from which the biochar is made. In the soil, biochar provides suitable conditions for soil microorganisms to flourish. The biochar is not substantially degraded by those microorganisms and so most of the biochar which is added to soil can remain in the soil for several hundreds to thousands of years. The biochar used in the present process may have a mean particle size of about 10 to about 1000 microns, or about 10 to 500, 10 to 200, 10 to 100, 100 to 500, 200 to 500, 50 to 500 or 50 to 200 microns, e.g. about 10, 20, 30, 40, 50, 60, 70, 80, 90, 100, 150, 200, 250, 300, 350, 400, 450, 500, 600, 700, 800, 900 or 1000 microns. It may be poly-dispersed. The particles may have irregular shapes. In some cases it may be necessary to comminute (e.g. crush or grind) the biochar in order to achieve the above mean particle size. In some cases the biochar may be surface modified before it is added to the mixing chamber. It may for example be oxidised or treated with a surface treating agent such as concentrated ammonia. This may use commonly known oxidising agents, such as phosphoric acid, nitric acid, organic peracids (e.g. peracetic acid), hydrogen peroxide, organic hydroperoxides or mixtures of any two or more of these. The biochar may be electroplated. This may for example comprise the step of applying to the biochar a sulphate or chloride of a metal (as these are commonly water soluble). Suitable metals include iron, manganese and copper. In water these may form the corresponding hydroxide which may crystallize and precipitate on the biochar. For example, Goetite as a hydroxide is largely insoluble in water however when derived from iron sulphate, which is water soluble, the Goetite can deposit, aided by an electric field, on the surface of the biochar. Metals may be electrodeposited on the surface of the biochar by using the biochar as a negatively charged electrode. The coating so formed may be about 1 nm to about 100 microns thick or about 1 nm to 10 microns, 1 nm to 1 micron, 1 to 100 nm, 1 to 10 nm, 10 nm to 100 microns, 100 nm to 100 microns, 1 to 100 microns, 10 to 100 microns, 10 nm to 20 microns, 100 nm to 20 microns, 1 to 20 microns, 10 to 20 microns, 10 nm to 1 micron, 10 to 100 nm, 100 nm to 10 microns, 100 nm to 1 micron, 1 to 10 microns, 10 to 100 microns or 50 to 500 nm, e.g. about 1, 2, 3, 4, 5, 10, 120, 30, 40, 50, 60, 70, 80, 90, 100, 200, 300, 400, 500, 600, 700, 800 or 900 nm or about 1, 2, 3, 4, 5, 6, 7, 8, 9, 10, 15, 20, 25, 30, 35, 40, 45, 50, 60, 70, 80, 90 or 100 microns. The surface modification may serve to introduce reactive groups, optionally hydrophilic groups, onto the surface of the biochar. It may serve to make the surface more reactive, or more hydrophilic, or more adsorbent, or more than one of these. It may for example introduce hydroperoxide groups onto the surface of the biochar.
Clay—the clay should preferably be, or should preferably comprise, a swelling clay. This allows organic matter to penetrate between the platelets of the clay, i.e. to intercalate or pillar the clay. This process is termed “pillaring” The clay may be combination of non-swelling and swelling clays. A suitable swelling clay material may be for example montmorillonite. Commonly montmorillonite itself will not be used due to its cost, however clays comprising montmorillonite or other swelling clays are generally suitable.
Organic Matter—the organic matter commonly comprises proteins, oligopeptides and/or amino acids. It may be, or may comprise, or may be derived from, waste matter or compost. For example chicken manure, pig waste or other animal derived or plant derived farming waste may be used as the organic matter. These wastes are commonly high in nitrogen, e.g. in the form of protein and/or degradation products thereof. There inclusion in the mixture provides a valuable source of nitrogenous matter and optionally trace minerals. It may additionally or alternatively be, or comprise, or be derived from, such organic matter as sawdust, shredded bark, leaf mulch etc. It may be in solid and/or in liquid form. In some instances the organic matter may, without suitable treatment, be toxic to plants with which the composition is to be used. This may be overcome by acid treatment of the organic matter. The acid treatment may comprise addition of an acid to the organic matter. Suitable acids include mineral acids and/or phosphorus based acids, such as sulphuric acid, nitric acid, phosphoric acid, phosphorous acid. In some cases organic acids, e.g. strong organic acids, may also be used. The organic matter prior to acid treatment may have a pH of about 9 to about 11, or about 10 to 11, e.g. about 10.5. The acid treatment may bring the organic matter to a pH of about 6 to about 7, or about 6 to 6.5 or 6.5 to 7, e.g. about 6, 6.1, 6.2, 6.3, 6.4, 6.5, 6.6, 6.7, 6.8, 6.9 or 7. In some instances the organic matter may be naturally at a pH of about 6 to about 7, or about 6 to 6.5 or 6.5 to 7, e.g. about 6, 6.1, 6.2, 6.3, 6.4, 6.5, 6.6, 6.7, 6.8, 6.9 or 7.
Non-Clay Minerals—these may be added separately, or may be part of the organic matter described above. They may for example be trace minerals such as iron, manganese, titanium or rare earth metals (such as lanthanum, caesium, thorium, neodymium, samarium and ytterbium) or titanium, vanadium, cobalt, niobium, ruthenium or molybdenum, commonly in the form of salts (e.g. sulphates or chlorides or oxides or hydroxides or carbonates) and/or complexes thereof. Any one of more of these may be used. The non-clay minerals may additionally comprise silicon-containing materials, e.g. silica, sand, silicates or a mixture of any two or more of these. Other suitable materials include calcium carbonate, e.g. from sea shells, mineral deposits or other sources. Sand and/or silica may be used in order to provide a low slump material. Calcium sand (i.e. a mixture of sand and calcium carbonate) may also be. used. Soluble or partially soluble or sparingly soluble forms of silica may be used in order to provide a source of silicon to crops which require this.

During the mixing step to form the pillared mixture, the mixing vessel may be heated. It may be heated electrically or it may be heated by means of a heated jacket. In some cases the jacket may be fed with a hot gas. This may be obtained as the exhaust gas from the torrefier, thereby using the heat of the exhaust gas and reducing the energy input to the system. In some embodiments of the invention the mixing is conducted as a continuous process, e.g. using a single or a twin screw mixer as the mixing vessel. In other embodiments, the process may be conducted as a semi-continuous process. In this case, two or more mixing vessels are provided. In yet other embodiments, the mixing is conducted in the same vessel as the torrefaction. In an example, a mixture is mixed in a first mixing vessel to form a pillared mixture. Once pillaring is complete in the first mixing vessel, this is passed to a continuous torrefier (see below). As this transfer is being conducted, a mixture is mixed in a second mixing vessel to form a pillared mixture. When transfer of the contents of the first mixing vessel is complete, the pillared mixture in the second mixing vessel is passed to the torrefier. As this transfer is being conducted, a mixture is mixed in the first mixing vessel to form a pillared mixture so as to restart the process. In this way a continuous source of pillared mixture is supplied to the torrefier.

In the process of pillaring, particles of the biochar are coated with the clay and the minerals. This may be at least in part due to electrostatic, covalent, ionic and/or ligand bonding between the biochar, minerals and clay. The coating of clay and minerals on the biochar may be between several microns and several nanometers thick. It may be about 10 nm to about 10 microns, or about 10 nm to 1 microns, 10 to 500 nm, 10 to 100 nm, 100 nm to 10 microns, 1 to 10 microns or 100 nm to 1 micron, e.g. about 10, 20, 30, 40, 50, 60, 70, 80, 90, 100, 150, 200, 250, 300, 350, 400, 450, 500, 600, 700, 800 or 900 nm, or about 1, 2, 3, 4, 5, 6, 7, 8, 9 or 10 microns thick. Additionally it is likely that particles of organic matter are also coated with clay and minerals. The pillared mixture is a highly heterogeneous mixture, with a variety of different types and sizes of particles. At least some of the particles comprise biochar particles having a coating of clay and minerals. Organic matter or derivatives thereof are likely to be located both in the clay, in particular at least partly intercalating the clay platelets, and partly in the biochar, either in the pores/channels thereof or on the surface or both.

The mixing vessel in which the pillaring occurs may be jacketed, as described elsewhere. It may be a batch mixer or a continuous mixer. It may be a ribbon mixer. It may be a paddle mixer. It may be some other type of mixer. It may have a central shaft having a mixing element coupled thereto for mixing the mixture therein. The mixing element may for example comprise a spiral ribbon for mixing the mixture.

The pillared mixture is passed into the torrefier, where it is heated to a suitable temperature. This is generally about 100 to about 290° C., or about 120 to about 290° C., or about 150 to about 250° C., or may be about 160 to about 250° C., or may be about 150 to 200, 160 to 200, 200 to 250, 220 to 250, 180 to 230, 180 to 210 or 220 to 240° C., e.g. about 150, 160, 180, 190, 200, 210, 220, 230, 240 or 250° C. In general the higher the temperature used in the torrefier, the shorter the residence time required. However, under certain circumstances a short residence time may be sufficient for a lower temperature to be used. The temperature in the torrefier may exceed 250° C. however it is preferred that the surface temperature of the pillared mixture (i.e. the temperature at the surface of the particles of the pillared mixture) does not exceed about 250° C. The temperature of the gas in the torrefier may be such that it does not exceed 250° C. The surface temperature of the particles in the torrefier may be such that it does not exceed 250° C. The surface temperature of the particles of the pillared mixture may remain in the range of about 150 to about 250° C. during the torrefaction. Typical residence times are in the range of about 0.5 to about 8 hours, or about 0.5 to 1, 1 to 5, 5 to 8 or 3 to 7 hours, e.g. about 0.5, 1, 2, 3, 4, 5, 6, 7 or 8 hours. Thus suitable conditions include about 180° C. for about 1 hour. The torrefier may be heated electrically or in some other manner. In one option the contents of the torrefier (i.e. the pillared mixture) are heated directly by injection of a heated gas into the torrefier. This may be at a single injection point, e.g. at the start of the torrefier, or may be at multiple injection points along the torrefier. In the latter case, these may be separated by a lineal distance of about 0.5 to 2 m, e.g. about 0.5, 1, 1.5 or 2 m. The heated gas is commonly at a temperature above the desired temperature in the torrefier. It may be about 50 to about 200° C. above the desired temperature in the torrefier, e.g. about 50, 100, 150 or 200° C. above the desired temperature. It may be for example at about 250 to about 450° C., or about 250 to 350, 350 to 450 or 300 to 400° C., e.g. about 250, 300, 350, 400 or 450° C. In some cases the heated gas may be an exhaust gas from a separate process. It may be an exhaust gas from a combustion process or a pyrolysis process. It may in particular be the exhaust gas from production of the biochar. In this way the waste heat obtained from the biochar production can be used in the torrefier. The heated gas may comprise carbon dioxide, carbon monoxide, nitrogen containing species or combinations of these. In some instances one or more of these substances may be at least partially incoroporated into the torrefied mixture. This may serve to increase the carbon content of the torrefied mixture. It may also serve to sequester part of the carbon dioxide and delay or prevent its release into the atmosphere.

The torrefier may comprise a central shaft having a series of projections extending therefrom. These may be arranged in a spiral orientation around the central shaft so as to both mix the mixture and transport it along the length of the torrefier. The torrefier preferably has a number of hot gas inlets along its length, optionally in gas communication with a manifold, for passing hot air into the torrefier so as to heat the mixture therein. These hot gas inlets may be disposed so as to allow the air to enter the torrefier approximately tangentially to an inner wall of the torrefier. There may also be a hot air inlet at one end of the torrefier for admitting hot gas to the torrefier. There may also be additional heating, e.g. electrical heating. The torrefier may also be externally heated. Examples of external heating means include hot gas, a liquid jacket or electric heating. The central shaft may be coupled to a motor for driving the shaft. It may be a variable speed motor so as to achieve a desired residence time (e.g. about 5 hours) of the mixture in the torrefier. The torrefier may have a jacket for retaining heat in the torrefier. The torrefier has an inlet at an inlet end and an outlet at an outlet end, for admitting mixture to the torrefier and allowing torrefied mixture to exit the torrefier respectively. It may also have an exhaust outlet, or a number of outlets (optionally manifolded) for allowing egress of gases generated in the torrefier, e.g. smoke chemicals, steam, hot air etc. The torrefier may resemble an industrial-sized oven and is designed to remove the moisture and toast the biomass. The torrefier is capable of physically and chemically altering the mixture as it passes through the torrefier. The torrefier may operate in a low oxygen environment, however it useful to have some oxygen present in order to oxidize various species in the mixture as it is torrefied.

In the torrefier, some breakdown of the organic matter is thought to occur. In particular, hydrolysis of proteinaceous matter in the organic matter may provide oligopeptides and/or amino acids from the proteins. As the pillared mixture contains about 5 to about 20% by weight of water (e.g. about 5, 10, 15 or 20%, commonly about 10% by weight), this water may be used for the hydrolysis of the proteins. Additionally in the torrefier, various species may migrate to other locations within the composition. For example organic molecules (e.g. amino acids, oligopeptides, proteins, sugars, saccharides etc.) may migrate between the clay and the biochar, or between the clay and solid organic matter in the composition.

The action of heat on the pillared mixture in the torrefier produces an exhaust gas. This gas commonly contains water vapour as well as a variety of compounds formed from thermal degradation of the organic matter. These compounds are collectively known as smoke chemicals, and may comprise aromatic and/or aliphatic compounds. There may be various carbonyl compounds such as aldehydes and ketones in the smoke chemicals. This exhaust gas is commonly generated at about the temperature in the torrefier, i.e. generally about 160 to about 250° C. This gas may then be passed to the jacket of the mixing vessel used to prepare the pillared mixture. This serves to heat the mixing vessel and thereby utilise the waste heat generated by the torrefier. As the exhaust gas heats the mixing vessel, the exhaust gas cools. In doing so, an aqueous liquid comprising at least some of the smoke chemicals may condense. The torrefier at least partially dries the mixture as it passes therethrough. Torrefication may be viewed as a mild pyrolysis.

The torrefied product exiting the torrefier is commonly in the form of a dry powder. At this stage one or more plant growth promoters may be combined with the dry powder. Suitable growth promoters include:

Small Molecule Oxygen and/or Nitrogen Functional Growth Promoters: these include small molecules (typically having molecular weight less than about 1000, commonly less than about 500) containing functional group such as butenolides, carboxyl groups, quinone groups, lactone groups, carbonyl groups, hydroxyl groups, cyclic amides, amines, nitrile groups, esters, ketones or pyrrole like groups. The may for example be, or comprise, humic and/or fulvic acids. These compounds may have growth enhancing and/or growth promoting properties and/or signalling properties. Optionally in combination with other species in the composition, they may also be capable of changing gene-expression in soil biota and in plants. They may be capable of switching on silenced gene sequences, for example multi-cob formation per shank in Maize or multi-shank development in several axles of maize or multi-head formation in sunflower or may be capable of silencing unwanted gene sequences such as apical dominance in maize etc. They may also be capable of inducing an increase in chlorophyll concentration in leaves, increasing root formation, changing stomata opening trigger levels and/or increasing heat, dryness and/or salt tolerance in plants.
Butenolides: these compounds are 2-furanones, for example 3-methyl-2H-furo[2,3-c]pyran-2-one. They may serve to encourage seed germination.
Salicylic Acid: Salicylic acid (o-hydroxybenzoic acid) is a plant hormone which contributes to healthy growth and development of plants. It promotes photosynthesis, ion transport, ion uptake and transpiration. It also functions as an immune system stimulant for plants, assisting in resistance to plant pathogens.

Molecules containing various functional groups, particularly oxygen and/or nitrogen containing functional groups (e.g. carboxyl groups, quinone groups, lactone groups, carbonyl groups, hydroxyl groups, cyclic amides, amines, nitrile groups, esters, ketones or pyrrole like groups) derived from biomass during charring or torrefaction, in combination with added compounds such as salicylic acid, chitin, chitosan, jasmonine etc. may not only have growth enhancing or promoting properties and signalling properties, but may also be capable of altering gene-expression in soil biota and in plants.

Chitin/Chitosan: chitosan is a polysaccharide derived from chitin. It has been used as a seed treatment and as a plant growth enhancer. It also may function to stimulate the plant's immune response towards pathogens.
Nitrogen Containing Polymer: these are a source of nitrogen for the growing plant. Slow degradation of the polymer in the soil, possibly mediated by microorganisms in the soil, provides low molecular weight nitrogen species which can promote plant growth. Suitable polymers include urea-formaldehyde and melamine formaldehyde polymers, which may generate urea and melamine respectively. They are commonly used in the process of the invention as powders so as to maximise their surface area. The nitrogen containing polymers therefore may act as a slow release source of nitrogen to the plant.

The dry powder is commonly combined with a liquid to form either a humidified powder or a slurry, either before, during or after combining with the plant growth promoters described above. The liquid is generally an aqueous liquid, e.g. water. The aqueous liquid which condenses from the exhaust gas in the jacket of the mixing vessel may suitably used to form the humidified powder or slurry, thus incorporating the smoke chemicals into the slurry. The liquid will generally be combined with the dry powder at about 1 to abut 50% by weight of the dry powder, or about 1 to 30, 1 to 10, 10 to 30, 20 to 50 or 20 to 40%, e.g. about 1, 5, 10, 20, 30, 40 or 50% by weight. Combining with an aqueous liquid may serve to cool the torrefied product as it exits the torrefier, thus enabling more rapid further processing if required. In some cases the slurry may be used as the composition for use in planting a crop. In some instances the dry powder or the humified powder from the torrefier may be used as the composition for use in planting a crop. More commonly however the slurry described above will be pelletised so as to form granules of the composition, which may be used in planting a crop. The process of pelletising may comprise applying the composition to a heated surface, e.g. a heated roller, so as to generate pellets or granules of the composition. In these granules the particles of the powdered composition are aggregated together into larger structures. The granules may have a mean diameter of about 1 to about 5 mm, or about 1 to 3, 3 to 5 or 2 to 4 mm, e.g. about 1, 2, 3, 4 or 5 mm. As some of the plant growth promoters are water soluble, the process of slurrying and pelletising may serve to incorporate at least some of the growth promoters in the particles, e.g. into the clay and/or into the pores/channels in the biochar. In order to promote cohesion of the granules produced by the pelletiser, a binder solution or mixture may be added to the slurry prior to pelletising. The binder may be biodegradable. It may for example be starch.

In some cases the composition, optionally in the form of a slurry or a paste, may be formed into a desired form and fired to produce a solid product. Desired forms may be for to example bricks or containers, e.g. pots. Thus for example a clay pot may be produced from the composition. The firing is commonly at a relatively low temperature so as not to adversely affect the composition, in particular the organic portions thereof. Thus firing may be at about 250 to about 350° C., or about 250 to 300, 300 to 350, 280 to 320, 280 to 300, 290 to 310, 290 to 300 or 295 to 300° C., e.g. about 250, 260, 270, 280, 290, 300, 310, 320, 330, 340 or 350° C. Pots made from the composition may be at least partially porous. In use, soil may be placed inside the pot, and a plant or seed or seedling planted therein. The pot may be located on or at least partially in soil. In such cases, as the plant grows, roots of the plant may grow through, or optionally break, the pot so as to access the soil outside the pot. Thus the composition provides the growth benefits of other forms of the composition while not preventing access of the roots to sufficient soil for growth.

Additionally, when rain or other water (e.g. irrigation water) falls on or is applied to the soil, it can solublise components of the composition so as to make them more available to the roots of the plant.

The torrefied product, either as a powder or as a slurry or as granules may be combined with a microbial preparation. The microbial preparation may for example comprise nitrogen fixing microbes, phosphorus mining microbes, cellulose and hemicellulose degrading microbes, hormone producing microbes, Mycorrhizae, etc. It may be added as a spray (of a dispersion of the microbes in water). Microbes can frequently assist a growing plant, for example by fixing nitrogen from the atmosphere or, by rendering bound phosphorus into plant available phosphorus, in the present instance, by assisting in degradation of the nitrogen containing polymer (if present) to produce nitrogenous compounds for use by the plant. It is important to add the microbes after any high temperature processing has been completed so as to avoid killing the microbes. The composition of the present invention may provide many features of a suitable environment for the microbes to flourish. In many embodiments however the composition is commonly dry. Thus the composition may not encourage growth of the microbes until water is added. This is conveniently when the composition is located in the soil when planting a crop.

In a broad form, the composition of the invention comprises biochar, intercalated clay, minerals and one or more plant growth promoter(s). It may be regarded as a stable organo-mineral-complex. The biochar and the clay have included (e.g. intercalated in the case of the clay, or located in pores/channels in the case of the biochar) organic matter and possibly also minerals. Thus the composition may represent firstly a sequestering medium for preventing carbon from reentering the atmosphere and secondly a slow release composition for use in planting seeds. The latter enables the composition to provide nutrients and specific plant growth promoters for healthy growth of a plant from a seed.

The plant growth promoter(s) represent either slow release nitrogen sources or specific compounds known to enhance growth of plants, for example by enhancing or stimulating the plant's immune response.

The composition may be in the form of a powder or a slurry or a granular composition. The particular form depends at least in part on the desired apparatus for applying the composition to soil. A granular composition is commonly used as this is convenient to apply, and reduces the hazards associated with dust and small particle size powders. However in whichever form the composition is provided, it will contain particles which have a mean particle size of about 10 to about 1000 microns, or about 10 to 500, 10 to 200, 10 to 100, 100 to 500, 200 to 500, 50 to 500 or 50 to 200 microns, e.g. about 10, 20, 30, 40, 50, 60, 70, 80, 90, 100, 150, 200, 250, 300, 350, 400, 450, 500, 600, 700, 800, 900 or 1000 microns. Some of these particles will comprise biochar particles surrounded by a layer comprising clay and minerals, although other structures, for example solid particles derived from the organic matter and surrounded by a layer of clay and minerals, may also be present. The clay and minerals may serve to provide protection to the materials coated thereby, and may serve to control release of organic matter to the soil from the composition.

The composition of the invention may be stable for a considerable time, particularly if maintained substantially dry. It may be stable for at least about a year, or at least about 2, 3, 4 or 5 years at room temperature, or for about 1 to about 10 years, or about 2 to 10, 5 to 10, 1 to 5 or 2 to 5 years, e.g. for about 1, 2, 3, 4, 5, 6, 7, 8, 9 or 10 years or longer. In this context, “stable” indicates that it remains capable of performing its intended function with substantially the same effectiveness after (i.e. at the end of) the stated period.

The composition of the invention may be used for promoting growth of a crop. The composition may encourage microbial and/or plant growth. It may encourage growth of beneficial fungi. It may improve the carbon content of the soil. It may increase the rate of germination. Thus as seeds are inserted into the soil, the composition is also located in the soil. Direct contact of very small roots which form from the seed with the composition may be damaging to those roots. It is therefore preferable if the composition is located some distance from the seed, so that the roots have the opportunity to grow larger before encountering the composition. However components of the composition, particularly soluble components such as butenolide, salicylic acid, chitin/chitosan, amino acids etc., may diffuse through the soil to the seed in order to promote growth of the seed into a plant from the earliest stage. The composition may be located in the soil to the side of the seed. It may be located in the soil below the seed. Commonly the composition will be added in a comparable quantity to an amount of fertiliser (e.g. chemical fertiliser or the usual fertiliser that is usually used for the particular type of crop) that would be normally used when planting the crop. It may be for example less than about 200% of the normal amount of fertiliser, or less than about 150 or 100 or 50 or 10%, or about 1 to about 200%, or about 1 to 100, 1 to 50, 1 to 20, 1 to 10, 10 to 100, 10 to 50, 50 to 100, 100 to 200 or 100 to 150% of the normal amount of fertiliser, e.g. about 1, 5, 10, 20, 30, 40, 50, 60, 70, 80, 90, 100, 110, 120, 130, 140, 150, 160, 170, 180, 190 or 200% thereof. The composition may be added at about 1 to about 5 tonnes per hectare, or about 1 to 3, 3 to 5 or 2 to 4 tonnes per hectare, e.g. about 1, 1.5, 2, 2.5, 3, 3.5, 4, 4.5 or 5 tonnes per hectare. At times the application rate may be more than 5 tonnes per hectare or less than 1 tonne per hectare, depending on the requirements of the crop and the quality of the existing soil. The method of planting crops may include the step of assessing the quality of the existing soil. It may further include the step of using the resulting assessment to determine an appropriate application for the particular crop to be planted in the particular soil.

The composition may be located in the soil at a distance of about 3 to about 15 cm from the seed, or about 5 to 15, 5 to 10, 10 to 15, or 3 to 10 cm from the seed e.g. about 3, 4, 5, 6, 7, 8, 9, 10, 11, 12, 13, 14 or 15 cm from the seed. It will commonly be located in the soil using a mechanical planter, using the same technology as would normally be used for planting seeds and locating fertiliser near the seeds. The distance from the seed used for the present composition may be comparable to the distance used for a normal fertiliser. It may be for example less than about 200% of the distance for a normal fertiliser, or less than about 150 or 100 or 50 or 10%, or about 1 to about 200%, or about 1 to 100, 1 to 50, 1 to 20, 1 to 10, 10 to 100, 10 to 50, 50 to 100, 100 to 200 or 100 to 150% of the distance for a normal fertiliser, e.g. about 1, 5, 10, 20, 30, 40, 50, 60, 70, 80, 90, 100, 110, 120, 130, 140, 150, 160, 170, 180, 190 or 200% thereof.

The composition of the invention may be used for promoting growth of a crop which is planted as seedlings and/or juvenile plants. It may improve the yield of a crop. It may improve the quality of a crop (e.g. the protein value or protein content). It may improve the vigour of the crop. It may increase the growth rate of a crop. Thus as seedlings and/or juvenile plants are inserted into the soil, the composition is also located in the soil. Direct contact of very small roots which form from the seedlings and/or juvenile plants with the composition may be damaging to those roots. It is therefore preferable if the composition is located some distance from the seedlings and/or juvenile plants, so that the roots have the opportunity to grow larger before encountering the composition. However components of the composition, particularly soluble components such as butenolide, salicylic acid, chitin/chitosan, amino acids etc., may diffuse through the soil to the seedlings and/or juvenile plants in order to promote growth of the seedlings and/or juvenile plants into a plant from the earliest stage. The composition may be located in the soil to the side of the seedlings and/or juvenile plants. It may be located in the soil below the seed. Commonly the composition will be added in a comparable quantity to an amount of fertiliser (e.g. chemical fertiliser or the usual fertiliser that is usually used for the particular type of crop) that would be normally used when planting the crop. It may be for example less than about 200% of the normal amount of fertiliser, or less than about 150 or 100 or 50 or 10%, or about 1 to about 200%, or about 1 to 100, 1 to 50, 1 to 20, 1 to 10, 10 to 100, 10 to 50, 50 to 100, 100 to 200 or 100 to 150% of the normal amount of fertiliser, e.g. about 1, 5, 10, 20, 30, 40, 50, 60, 70, 80, 90, 100, 110, 120, 130, 140, 150, 160, 170, 180, 190 or 200% thereof.

The composition may be located in the soil at a distance of about 3 to about 15 cm from the seedlings and/or juvenile plants, or about 5 to 15, 5 to 10, 10 to 15, or 3 to 10 cm from the seedlings and/or juvenile plants e.g. about 3, 4, 5, 6, 7, 8, 9, 10, 11, 12, 13, 14 or 15 cm from the seedlings and/or juvenile plants. It will commonly be located in the soil using a mechanical planter, using the same technology as would normally be used for planting seedlings and/or juvenile plants and locating fertiliser near the seedlings and/or juvenile plants. The distance from the seedlings and/or juvenile plants used for the present composition may be comparable to the distance used for a normal fertiliser (e.g. normal chemical fertiliser). It may be for example less than about 200% of the distance for a normal fertiliser, or less than about 150 or 100 or 50 or 10%, or about 1 to about 200%, or about 1 to 100, 1 to 50, 1 to 20, 1 to 10, 10 to 100, 10 to 50, 50 to 100, 100 to 200 or 100 to 150% of the distance for a normal fertiliser, e.g. about 1, 5, 10, 20, 30, 40, 50, 60, 70, 80, 90, 100, 110, 120, 130, 140, 150, 160, 170, 180, 190 or 200% thereof.

The composition of the invention may be used in broad acre cultivation, turf/nursery applications, other horticultural applications, tree production and land rehabilitation. It may serve to increase the water holding capacity of the soil. It may serve to increase the cationic interchange capacity of the soil. It may promote greater, or more rapid, plant growth. It may stimulate germination of seeds. It may change gene expression in soil biota and plants. It may improve the immune system of the plants. It may improve vigour of growing plants. It may promote plant growth at least about 5% faster or at least about 10% faster, or greater, than in the absence of the composition. It may promote plant growth at least 5, 10, 15, 20, 25, 30, 35, 40, 45 or 50% faster, or greater, than in the absence of the composition. Biochar that has been processed or obtained separately to the composition of the invention may also be used in combination therewith. Such biochar may be applied prior to or together with the composition of the invention.

The composition may improve the growth and/or yield and/or quality of a mature crop as well as that of an immature crop such as seeds, seedlings etc. Thus if the composition is applied to the soil (either to the surface thereof or under the surface thereof or both) proximate the mature crop, this may promote the health, vigour etc. of the crop. The crop may be a tree, a grain, a vegetable or any other sort of desired plant.

A device for making the composition comprises a mixer coupled to a torrefier. It may additionally comprise a biochar furnace for producing biochar for use in the process. The biochar furnace may have a post treatment unit for surface oxidising or electroplating the biochar produced in the furnace. The biochar furnace may comprise an exhaust line leading to the torrefier, for passing heated exhaust gas to the torrefier so as to heat the contents thereof in operation. The torrefier comprise a torrefier exhaust line for conveying exhaust gases from the torrefier to a heating jacket of the mixer so as to heat the mixer. The heating jacket may comprise a drain line for draining condensate formed from the exhaust gases from the torrefier. There may be a roller/crusher located between the mixer and the torrefier for crushing the pillared mixture from the mixer prior to its entering the torrefier. There may be a further roller/crusher for breaking up aggregates formed in the torrefier. A post-mixer may be provided for adding the plant growth promoter(s) and optionally other additives. A feed line coupled to the drain line of the mixer may also feed into the post-mixer for supplying the condensed aqueous liquid to the post-mixer in order to form a slurry or a humidified powder.

The post-mixer is disposed so as to feed the slurry to a granulator for generating granules of the composition, and an inoculator may provided after the granulator for adding microbes to the granules.

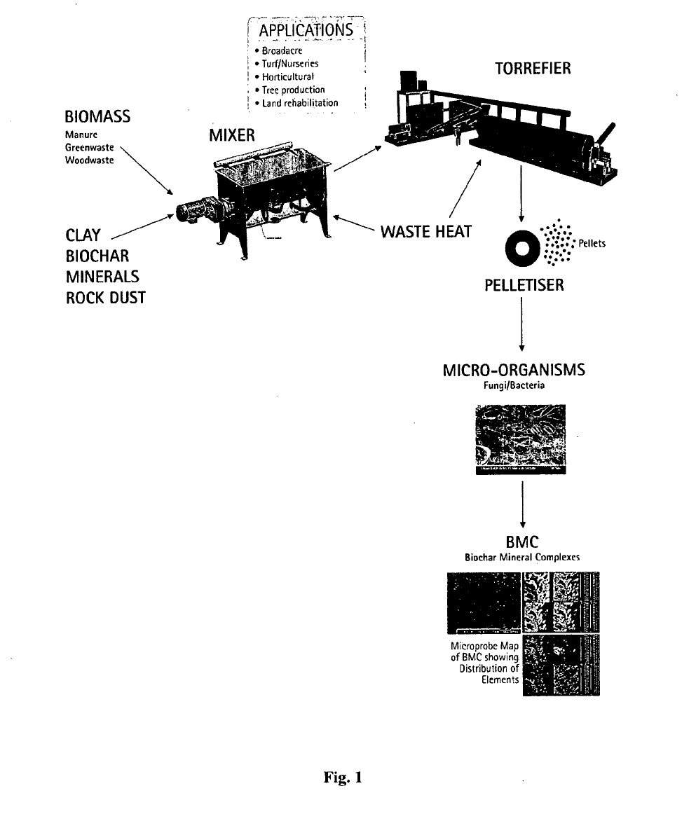

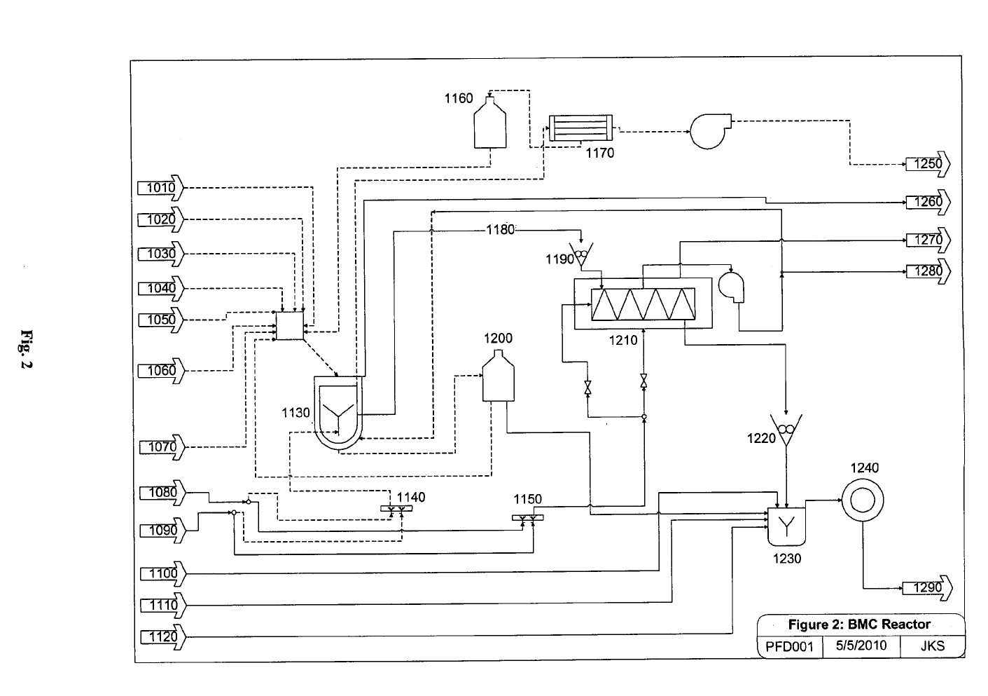

A diagrammatic representation of the process is shown in FIG. 1. FIG. 2 shows a flow chart of the process for producing the composition of the invention. With reference to FIG. 2, the numbers refer to the following:

| | |
|---|---|
| 1010 | Town water |
| 1020 | Manure biomass |
| 1030 | Mixer clay |
| 1040 | Acetic/citric acid |
| 1050 | Mineral mix |
| 1060 | Oxidised char |
| 1070 | Woody biomass |
| 1080 | Air |
| 1090 | LPG |
| 1100 | Proteins |
| 1110 | BMC clay |
| 1120 | 3% Starch solution |
| 1130 | Mixer (1 of 2) |
| 1140 | Mixer burner |
| 1150 | Reactor burner |
| 1160 | Drier condensate tank |
| 1170 | Air cooled condenser |
| 1180 | Raw BMC mixture to BMC reactor |
| 1190 | Roller crusher |
| 1200 | BMC reactor water tank |
| 1210 | BMC reactor |
| 1220 | Roller crusher |
| 1230 | Post mixing |
| 1240 | Granulator |
| 1250 | Mixer exhaust |
| 1260 | Mixer exhaust |
| 1270 | Reactor burner exhaust |
| 1280 | Reactor exhaust |
| 1290 | BMC product |

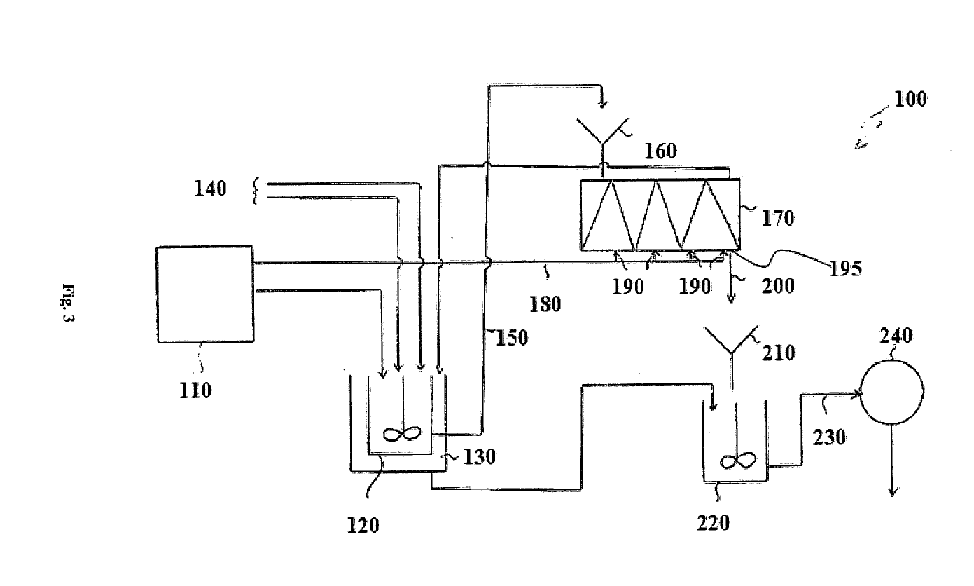

FIG. 3 shows a simplified version of the flow chart shown in FIG. 2. In FIG. 3, apparatus 100 comprises biochar kiln or substoichiometrically operated wood furnace 110 disposed to feed biochar to mixer vessel 120. Mixer vessel 120 is partially surrounded by heating jacket 130 for accepting a heating fluid so as to heat the contents of vessel 120. Other feed lines 140 are provided for conveying clay, organic matter etc. to mixer vessel 120. Line 150 leads from mixer vessel 120 so as to convey pillared mixture from vessel 120 to crusher 160. Crusher 160 feeds crushed pillared mixture to torrefier 170. A heated gas line 180 is provided to take heated exhaust gas from biochar furnace 110 to torrefier 170, feeding into multiple entrance ports 190 along the length of torrefier 170. Line 200 leads from the outlet 195 of torrefier 170 to crusher 210, which feeds crushed torrefied product into post-mixer 220. A drain line leads from heating jacket 130 to post-mixer 220 so as to take condensate formed in heating jacket 130 and feed it to post-mixer 220. In some cases a storage tank (not shown in FIG. 3) may be provided so as to store the condensate before delivering it to post-mixer 220. A line 230 takes the slurry formed in post-mixer 220 to pelletiser 240 so as to produce the composition as granules.

In operation of apparatus 100, combustion of biomass such as wood in furnace 110 provides biochar, which is passed to mixer vessel 120. Mixer vessel 120 is also fed with clay, organic matter etc. from feed lines 140. The resulting mixture in vessel 120 is stirred and is also heated by means of jacket 130, which received heated gas from torrefier 170. In doing so, liquids condense from the gas and are passed to post-mixer 120. The pillared mixture produced in vessel 120 then passes into torrefier 170 through line 150. On the way it is crushed by crusher 160 so as to achieve a suitable particle size. As the mixture passes through torrefier 170, it is heated by means of hot waste gases which come from furnace 110 by way of line 180 and ports 190. On exiting torrefier 170 (through outlet 195 and line 200), the mixture is again crushed using crusher 210 and fed to post-mixer 220. The crushed, torrefied mixture is then mixed with smoke chemicals condensed in jacket 130. It then passes into pelletiser 240, which pelletises the mixture to form pellets of the final product.

### EXAMPLES

### Example 1

An analysis was performed on two Biochar-Mineral Complexes (BMCs) according to the present invention: BMC 7/09 and BMC 8/09. Table 1 shows the methods used for analysis of both BMCs. R&H means Rayment and Higginson, USEPA means United States Environmental Protection Agency and in-house methods 235 and 236 are based on R&H methods 6B1 and 6A1, respectively. Samples were air dried at 40° C. in dehydrators according to Method 1B1 (Rayment and Higginson, 1992). The results of the each analysis are shown in Table 2. Results are expressed on a dry weight basis unless otherwise stated.

TABLE 1

| Analytical Method | Method Number |
|---|---|
| Determination of Gillman and Sumpter Exchangeable | R&H 15E1 |
| Cations by ICP | USEPA 6010 |
| Organic Carbon % (Walkley & Black) | In-house 236 |
| Total Nitrogen and Total Carbon by Dumas | In-house 630 |
| Combustion Method | |
| Acid Extraction | USEPA 3050B |
| Acid Extractable Elements and Metals by ICP | USEPA 6010 |
| Available Orthophosphate Phosphorus in Soil Using | R&H 9E2 |
| Bray #1 Extraction | |
| Mineral Nitrogen KCl Extraction | R&H 7C2 |

TABLE 2

| | | Limit of | BMC | BMC |
|---|---|---|---|---|
| | Unit | Reporting | July 2009 | August 2009 |
| KCl Extractable | mg/kg | 0.3 | 30 | 520 |
| Ammonium-N | | | | |
| KCl Extractable | mg/kg | 0.2 | <0.2 | 100 |
| Nitrate-N | | | | |
| Bray #1 Phosphorus | mg/kg | 0.06 | 1300 | 890 |
| Organic Carbon | % | 0.05 | 7.1 | 7.7 |
| Total Nitrogen | % | 0.02 | 1.4 | 0.93 |
| Total Carbon | % | 0.20 | 37 | 36 |
| Exchangeable | | | | |
| Cations | | | | |
| Aluminium | cmol(+)/kg | 0.01 | 0.25 | 1.8 |
| Calcium | cmol(+)/kg | 0.01 | 28 | 26 |
| Potassium | cmol(+)/kg | 0.02 | 21 | 25 |
| Magnesium | cmol(+)/kg | 0.008 | 7.4 | 8.6 |
| Sodium | cmol(+)/kg | 0.02 | 6.8 | 3.9 |
| CEC | cmol(+)/kg | | 63 | 65 |
| Calcium/Magnesium | | | 3.7 | 3 |
| Ratio | | | | |
| Aluminium | % | | 0.39 | 2.8 |
| Saturation | | | | |
| Exchangeable | % | | 44 | 40 |
| Calcium | | | | |
| Exchangeable | % | | 33 | 38 |
| Potassium | | | | |
| Exchangeable | % | | 12 | 13 |
| Magnesium | | | | |
| Exchangeable | % | | 11 | 5.9 |
| Sodium | | | | |
| Total Elements | | | | |
| Aluminium | % | 0.0005 | 2.0 | 2.3 |
| Arsenic | mg/kg | 5 | <5 | <5 |
| Boron | mg/kg | 4 | 18 | 15 |
| Calcium | % | 0.0003 | 7.5 | 7.2 |
| Cadmium | mg/kg | 0.2 | 4.3 | 5.5 |
| Cobalt | mg/kg | 0.4 | 13 | 14 |
| Chromium | mg/kg | 0.2 | 36 | 38 |
| Copper | mg/kg | 0.2 | 44 | 43 |
| Iron | % | 0.00003 | 1.5 | 1.2 |
| Potassium | % | 0.0004 | 1.3 | 1.3 |
| Magnesium | % | 0.00006 | 0.28 | 0.22 |
| Manganese | mg/kg | 0.1 | 6500 | 5800 |
| Molybdenum | mg/kg | 0.3 | <0.3 | <0.3 |
| Sodium | % | 0.0005 | 0.21 | 0.12 |
| Nickel | mg/kg | 0.7 | 17 | 17 |
| Phosphorus | % | 0.0003 | 2.8 | 3.1 |
| Lead | mg/kg | 2 | 6.6 | 8.8 |
| Sulfur | % | 0.0006 | 0.79 | 0.87 |
| Selenium | mg/kg | 4 | <4 | <4 |
| Zinc | mg/kg | 0.8 | 130 | 140 |

### Example 2

### Biochar-Mineral Complex as a Fertiliser Replacement

A Biochar-Mineral Complex (BMC) was prepared by torrification of a mixture of clay, organic matter and biochar with selected minerals. The total mineral analysis was N=1.2%, P=1.6%, K=0.8%, S=0.6%, Al=1.6%, Fe=1.5 and C=24% (including approximately 10% wood biochar). Experiments were performed in 2009 on two soils (red deep loamy duplex with Colwell P 30 ppm and yellow/brown deep sandy duplex with Colwell P 24 ppm). The area was chemical fallowed in 2008; plots 2.0 m wide and 30 m long were laid out in randomized block designs with four replicates. A crop of Westonia wheat was sown on 4 and 5 Jun. 2009. Starter fertiliser was either nil, single superphosphate or a range of biochar mineral complex fertilisers. Other nutrients were basaled; N and K were applied in June and July. The growing season rainfall was 340 mm. All sites had additional N and K added. The aim of the experiment was to see if BMC was a more effective replacement for P.

Table 3 shows the Mean Treatment Yields (t/ha) and the least significant difference (LSD) for 90% confidence from the two experiments comparing superphosphate (super) to a biochar-mineral complex inoculated with beneficial microbes from Western Minerals Fertilisers (BMCi) and the same biochar-mineral complex without inoculation (BMCu). A mean greater than that of the nil treatment at P<0.1 is indicated by a single asterisk (*).

In July 2009 there was higher than average rainfall and symptoms of nitrogen deficiency were observed at the sandy loam site. The largest yields and treatment yield differences were obtained from the site on loam soil which had more available P. Superphosphate increased yield for both soil types. Yield increase by un-inoculated BMC on the loam with the greater available P was almost significant at P<0.1.

TABLE 3

| | Mean Treatment Yield (t/ha) | | | | |
|---|---|---|---|---|---|
| | | 100 kg/ha | 100 kg/ha | 100 kg/ha | |
| Soil | nil | super | BMCi | BMCu | LSD 0.1 |
| Loam | 5.02 | 5.32* | 5.16 | 5.30 | 0.301 |
| Sandy loam | 3.09 | 3.23* | 3.10 | 3.11 | 0.134 |

### Example 3

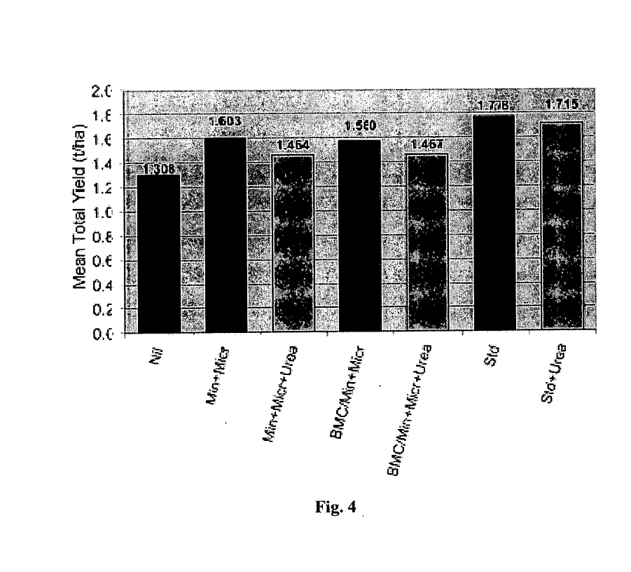

FIG. 4 shows a comparison of the Mean Total Yield (t/ha) of Bonnie Rock wheat crops to which were applied different combinations of fertiliser. “Min” corresponds to 100 kg/ha NPK Crop Plus; “Mic” corresponds to 750 g/t Ag Microbes on Seed; “BMC/Min” corresponds to 70 kg/ha NPK Crop B; “Std” corresponds to 70 kg/ha Macro Pro Extra plus 400 ml/ha intake in furrow; and “urea” corresponds to 27.5 kg/ha granular urea (4 w.a.s.). In each case 80 kg/ha of wheat was sown.

### Example 4

### Typical Chemical Analysis of BMC.

Table 4 shows a comparison of ash constituent analysis. Table 5 shows a comparison of proxy and ultimate analysis (element content) between char and BMC samples.

TABLE 4

| % | BMC | BMC | BMC | BMC | | | Red |
|---|---|---|---|---|---|---|---|
| Elements | February | March | May | June | STP | STP | Kaolin |
| in Ash | 2009 | 2009 | 2009 | 2009 | 220 | 240 | Clay |
| Si | 51.2 | 51.4 | 50 | 41.5 | 55.3 | 57.5 | 52.3 |
| Al | 18.2 | 19 | 15.5 | 15 | 21 | 19.5 | 29.2 |
| Fe | 6.2 | 5 | 4.5 | 4 | 3 | 3.1 | 13.8 |
| Ca | 11.6 | 11 | 12.7 | 20.2 | 9.7 | 9.1 | 0.08 |
| P | 4.4 | 4.1 | 6.8 | 11.8 | 4 | 4.1 | 0.01 |
| K | 2.2 | 2.3 | 2.3 | 3.3 | 1.9 | 2.1 | 0.32 |

TABLE 5

| | BMC | BMC | BMC | BMC | Saligna | Saligna | | | Red |
|---|---|---|---|---|---|---|---|---|---|
| | February | March | May | June | Char | Char | STP | STP | Kaolin |
| | 2009 | 2009 | 2009 | 2009 | (Untreated) | (Oxidised) | 220 | 240 | Clay |
| % Ash | 55 | 58.1 | 54.3 | | | | 61.3 | 77 | |
| % | 35 | 28.3 | 31.6 | | | | 19.3 | 13.4 | |
| Volatiles | | | | | | | | | |
| % Fixed | 6.5 | 9.9 | 12.5 | | | | 15.3 | 9.7 | |
| Carbon | | | | | | | | | |
| % | 21.8 | 20.4 | 26.9 | 33.5 | 70.7 | 68.4 | 21.4 | 13.7 | 0.16 |
| Carbon | | | | | | | | | |
| % | 2.2 | 2 | 2.33 | 1.35 | 3.4 | 2.58 | 1.4 | 0.83 | 1.07 |
| Hydrogen | | | | | | | | | |
| % | 0.9 | 1 | 1.2 | 0.95 | 0.66 | 1.78 | 1.8 | 1.35 | 0.03 |
| Nitrogen | | | | | | | | | |

### Example 5

### Typical Agronomic Analysis of High Mineral Content BMC

TABLE 6

| | BMC February 2009 | BMC March 2009 |
|---|---|---|
| Quartz | 10.2 | 11.7 |
| Apatite | 3.4 | 2.4 |
| Rutile | 0.3 | 0.3 |
| Carbonate (calcite and | 2.7 | 2.3 |
| aragonite) | | |
| Kaolinite | 18.5 | 13.1 |
| Muscovite | 2.8 | 2.7 |
| Illite | 3.6 | 2.5 |
| Amorphous Content | 58.5 | 65.1 |

TABLE 7

| | | Limit of | BMC | | |
|---|---|---|---|---|---|
| | Unit | Reporting | 2/3 | BMC 5 | BMC 6 |
| EC | dS/m | 0.01 | 2.9 | 3.6 | 0.01 |
| pH (CaCl₂) | | 0.04 | 6.0 | 5.7 | 7.9 |
| Colwell | mg/kg | 2 | 2100 | 2700 | 1800 |
| Phosphorous | | | | | |
| Bray Phosphorus | mg/kg | 0.06 | 1400 | 1500 | |
| Total Nitrogen | % | 0.02 | 1.1 | 1.2 | 1.1 |
| Total Carbon | % | 0.2 | 21 | 24 | 28 |
| KCl Extractable | mg/kg | 0.3 | 34 | 100 | 17 |
| Ammonium-N | | | | | |
| KCl Extractable | mg/kg | 0.2 | <0.2 | <0.2 | 0.32 |
| Nitrate-N | | | | | |
| Organic Carbon | % | 0.05 | 17 | 18 | 5.6 |
| ANC | % CaCO₃ | 0.5 | | 7.4 | 9.1 |
| | equivalent | | | | |
| Total Elements | | | | | |
| Aluminium | % | 0.00024 | 1.4 | 1.6 | 2 |
| Arsenic | mg/kg | 3 | <3 | <3 | <5 |
| Boron | mg/kg | 1.9 | 12 | 16 | 28 |
| Calcium | % | 0.00016 | 4.6 | 5.2 | 7.7 |
| Cadmium | mg/kg | 0.9 | 1.2 | 1.8 | 10 |
| Cobalt | mg/kg | 1.2 | 6.3 | 6.7 | 18 |
| Chromium | mg/kg | 1 | 27 | 27 | 29 |
| Copper | mg/kg | 0.9 | 24 | 24 | 43 |
| Iron | % | 0.00016 | 1.7 | 1.5 | 1.4 |
| Potassium | % | 0.0038 | 0.69 | 0.79 | 1.4 |
| Magnesium | % | 0.0001 | 0.38 | 0.45 | 0.27 |
| Manganese | mg/kg | 1 | 1400 | 6500 | 3300 |
| Molybdenum | mg/kg | 1.2 | <1.2 | <1.2 | 6.1 |
| Sodium | % | 0.0007 | 0.30 | 0.22 | 0.22 |
| Nickel | mg/kg | 1.3 | 8.9 | 17 | 4.2 |
| Phosphorus | % | 0.0003 | 1.1 | 1.6 | 3 |
| Lead | mg/kg | 1.7 | 10 | 12 | <2 |
| Sulfur | % | 0.0022 | 0.15 | 0.63 | 0.55 |
| Selenium | mg/kg | 6.6 | <6.6 | <6.6 | <4 |
| Zinc | mg/kg | 1.1 | 97 | 150 | |
| Exchangeable | | | | | |
| Cations | | | | | |
| Aluminium | cmol(+)/kg | 0.034 | 1.6 | 1.1 | 0.3 |
| Calcium | cmol(+)/kg | 0.013 | 29 | 29 | 25 |
| Potassium | cmol(+)/kg | 0.085 | 8.3 | 5.3 | 22 |
| Magnesium | cmol(+)/kg | 0.003 | 9.9 | 7.7 | 5 |
| Manganese | cmol(+)/kg | 0.001 | 2.5 | 6.7 | 1.3 |
| Sodium | cmol(+)/kg | 0.037 | 11 | 4.2 | 4.2 |
| Exchangeable | | | | | |
| Cations with | | | | | |
| Pre-Digestion | | | | | |
| Aluminium | cmol(+)/kg | 0.034 | 5.3 | 7.2 | |
| Calcium | cmol(+)/kg | 0.013 | 80 | 73 | |
| Potassium | cmol(+)/kg | 0.085 | 9.3 | 12 | |
| Magnesium | cmol(+)/kg | 0.003 | 17 | 22 | |
| Manganese | cmol(+)/kg | 0.001 | 4.5 | 21 | |
| Sodium | cmol(+)/kg | 0.037 | 12 | 8.4 | |

### Example 6

BMC consists of a wide range of particles that have different morphologies and different compositions. Some of the particles (surface activated biochar) have a high surface area, high cation exchange capacity, high aromaticity, and high concentration of functional groups. Other particles have a high labile carbon content, high mineral content which is plant available but has a lower surface area.

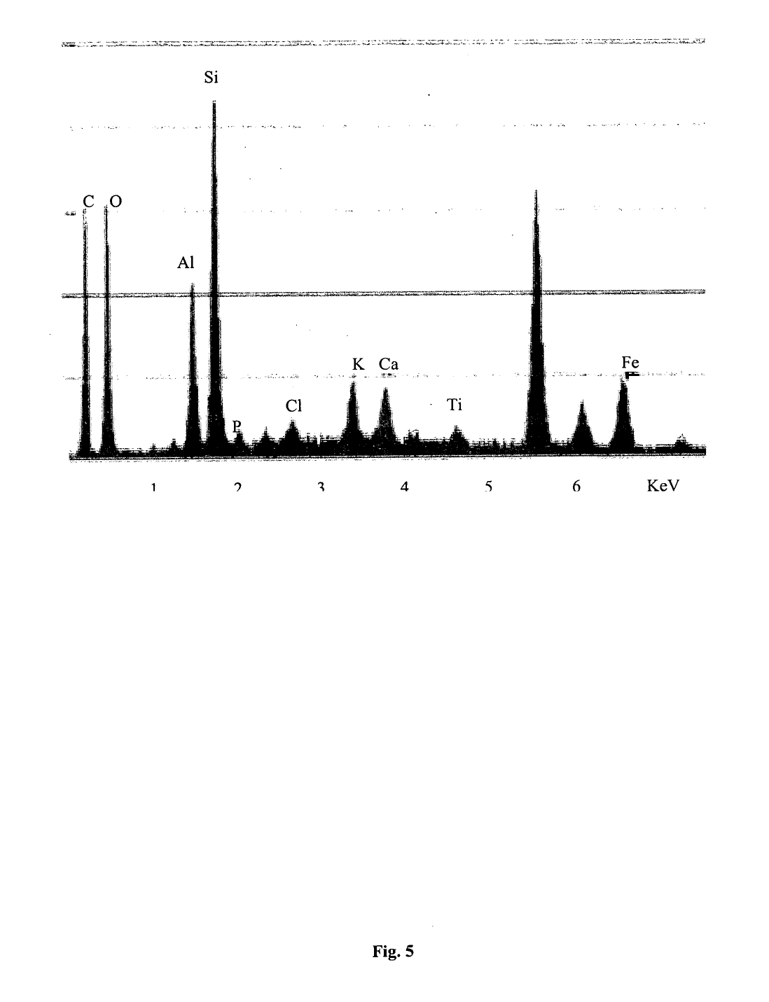

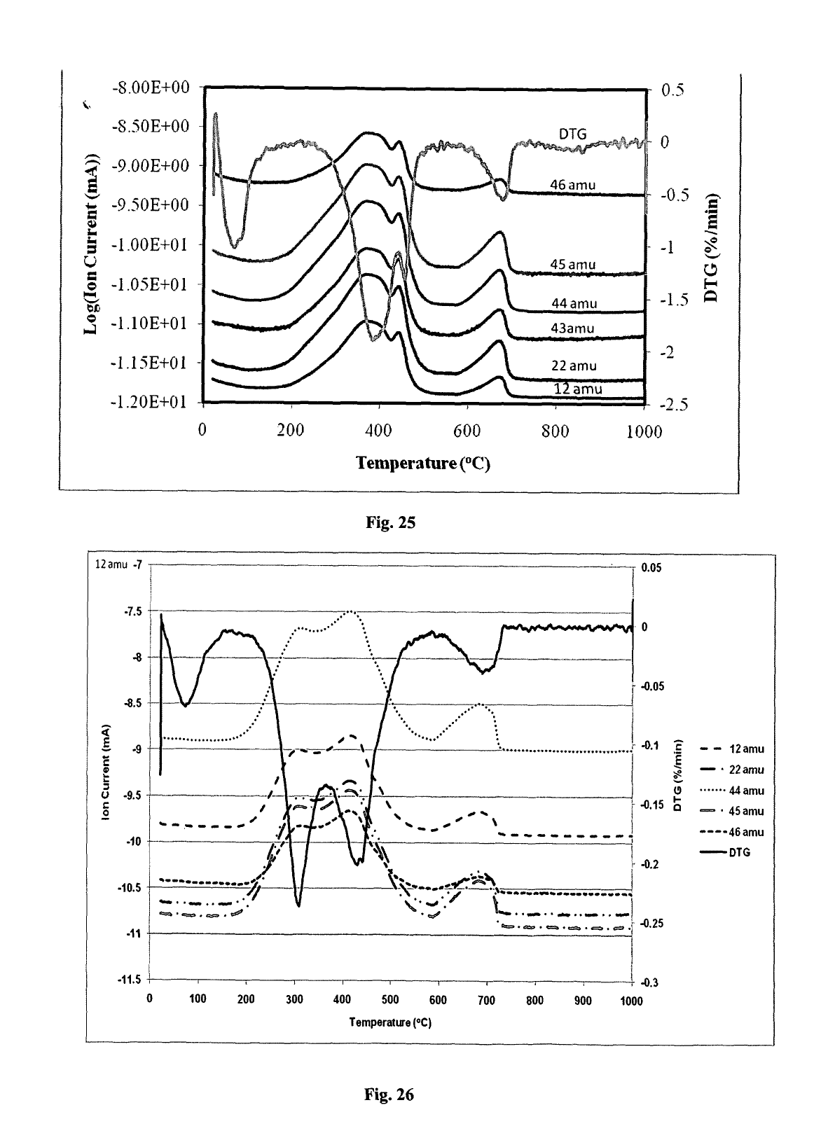

FIGS. 5 to 13 and 15 to 35 are a summary of a wide range of examination that has been undertaken by Prof Paul Munroe, Dr Y Lin, C Chia, Dr J Hook at University of New South Wales, Dr P Thomas at University of Technology Sydney Dr S Donne at University of Newcastle, Dr L van Zweiten, Mr S Kimber, Mr J Rust at New South Wales Department of Primary Industries, Dr Z Solaiman at University of Western Australia and Dr P Blackwell at Department of Agriculture and Food Western Australia.

### Example 7

### Wood Biochar Coated in Minerals

FIG. 5 shows a biochar surrounded by a clay mineral layer. Clay appears to have a Si/Al ratio of 2:1 and there is a high amount of Fe (>8%) and Mn (>4.25%). The amount of K and Ca are each around 3% with smaller amounts of P, S, Cl, Ti, Na and Mg.

### Example 8

### Porous Surface Structure of BMC

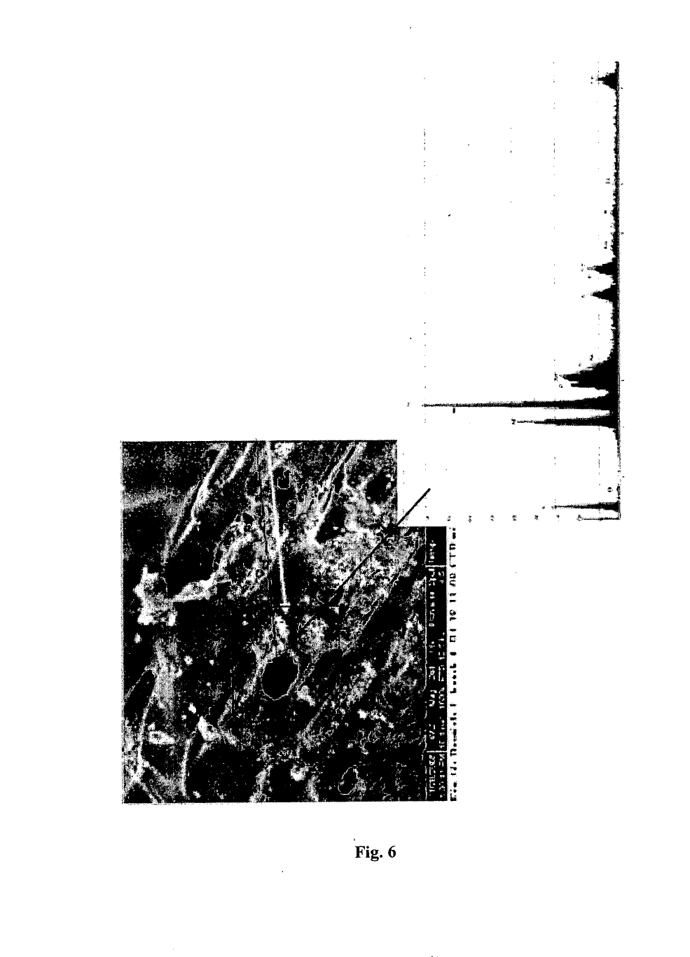

FIG. 6 shows a torrefied wood particle with a high concentration of Al, Si, P, K, Ca and Fe around one of the pores.

### Example 9

### Structure of BMC

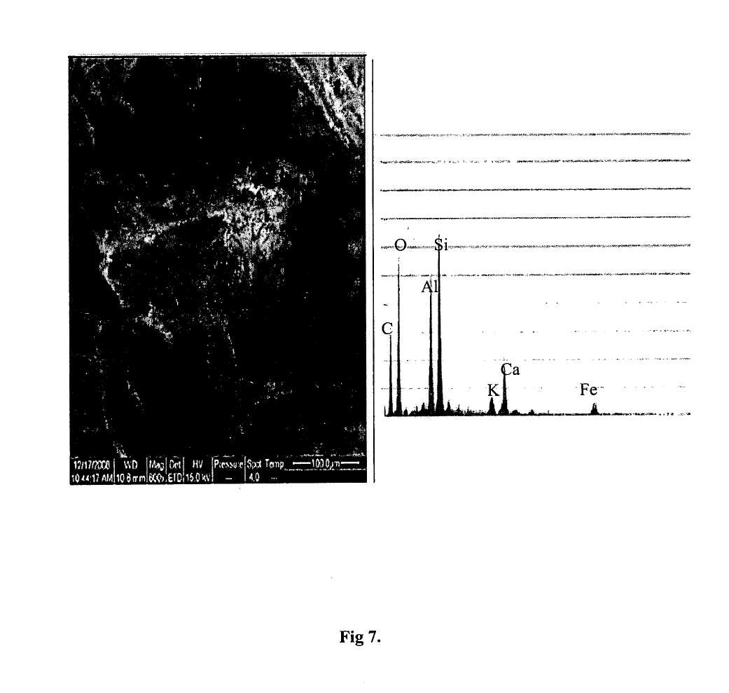

FIG. 7 shows torrefied chicken manure with a range of minerals on the surface.

### Example 10

### Structure of BMC

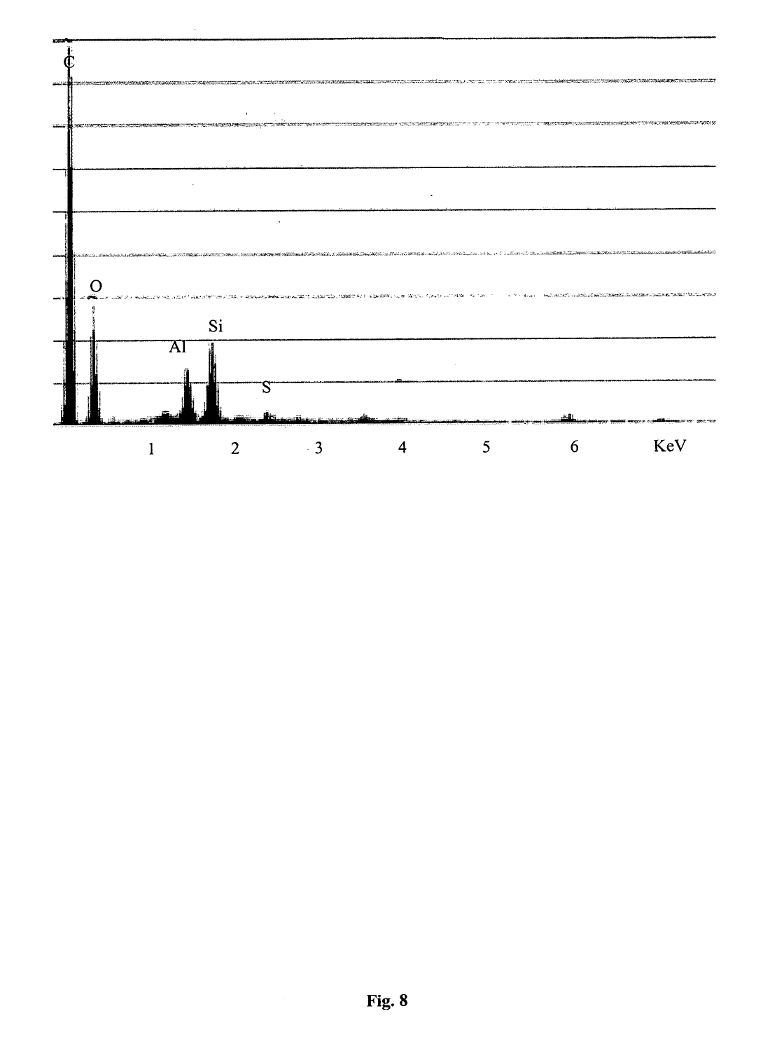

FIG. 8 shows biochar oxidised with acid and coated with clay and minerals to give a high surface area and high cation exchange.

### Example 11

### Nano-Structure of BMC

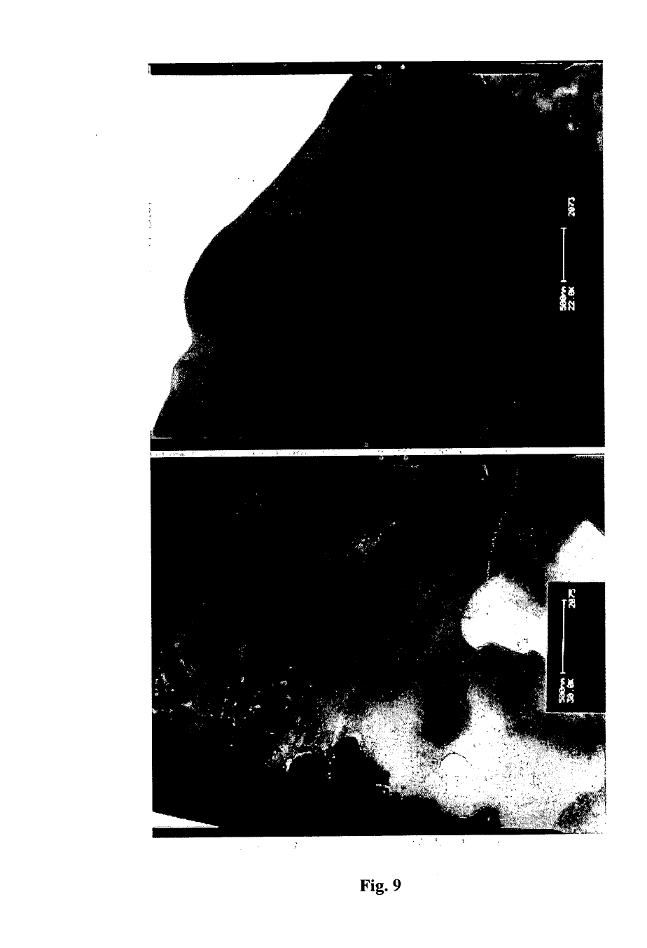

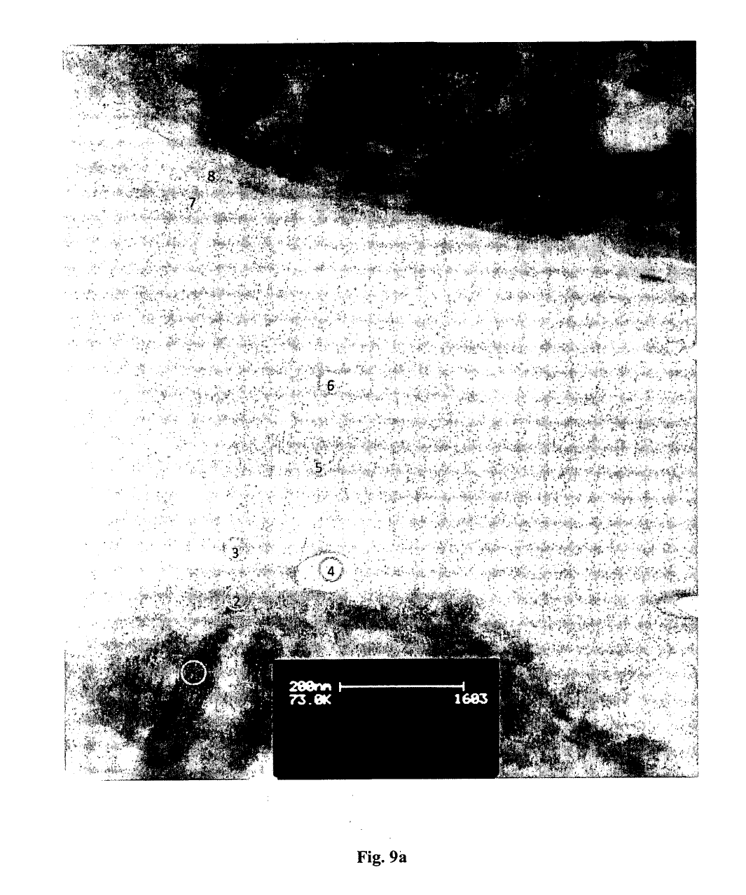

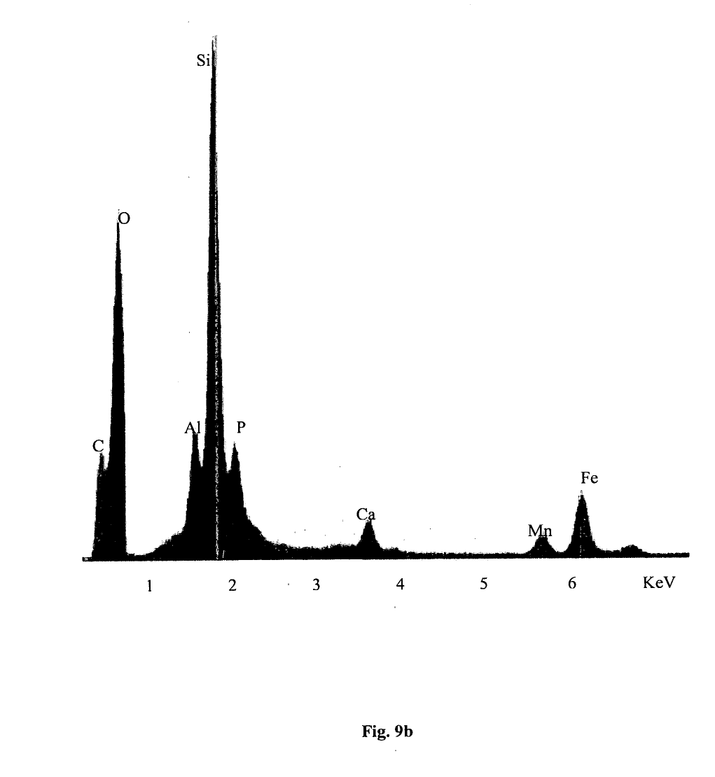

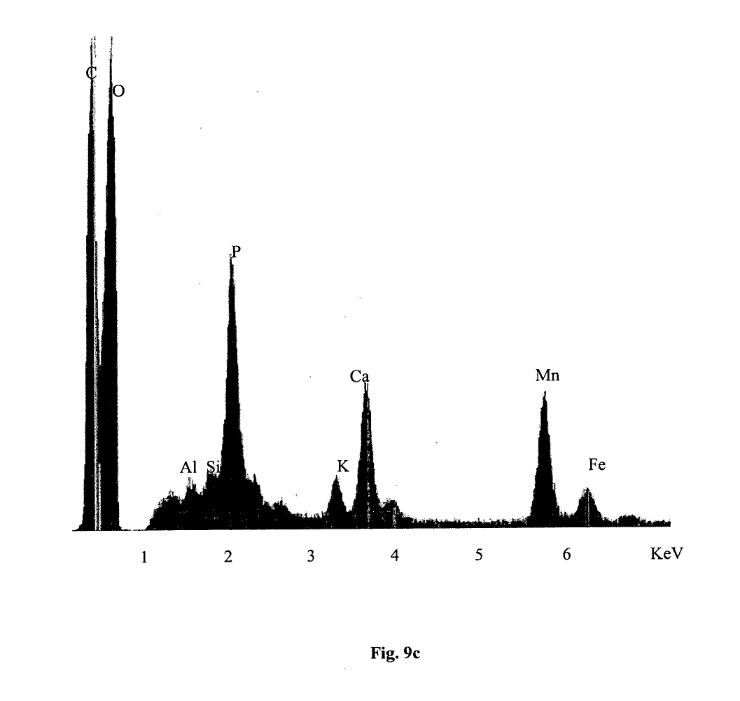

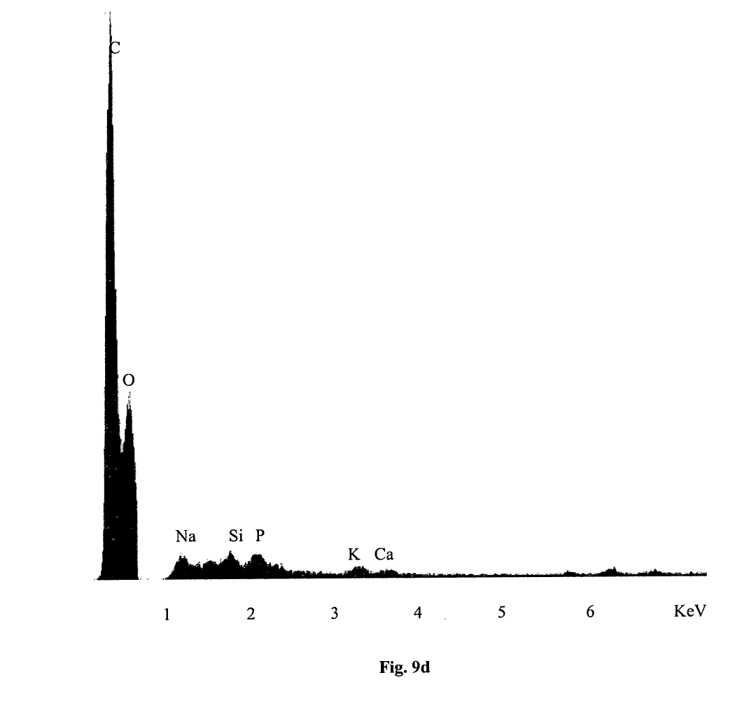

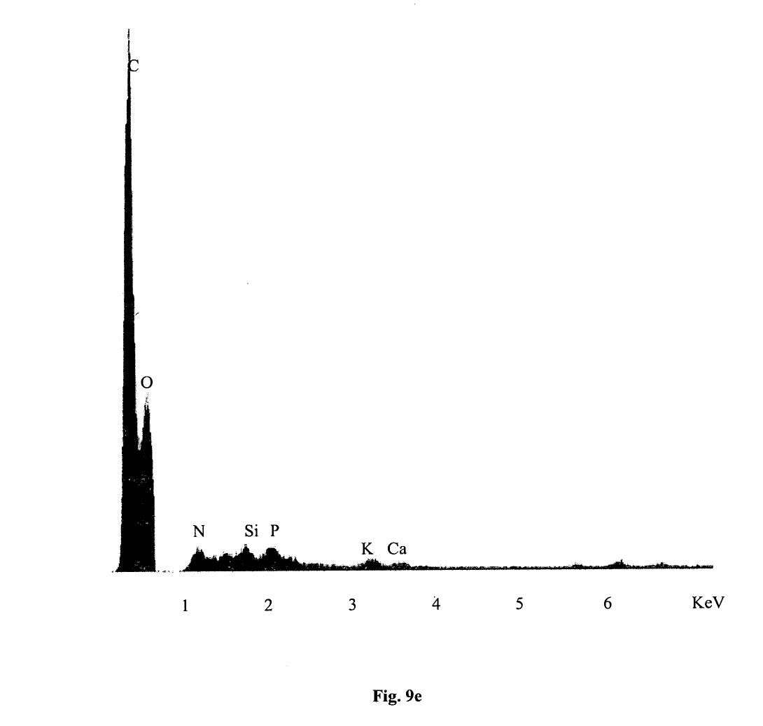

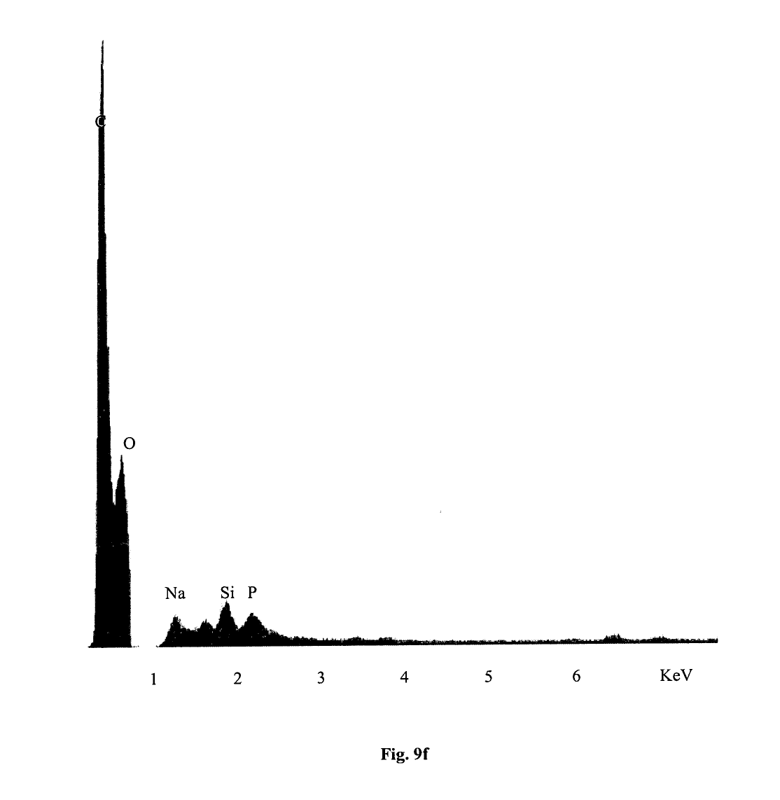

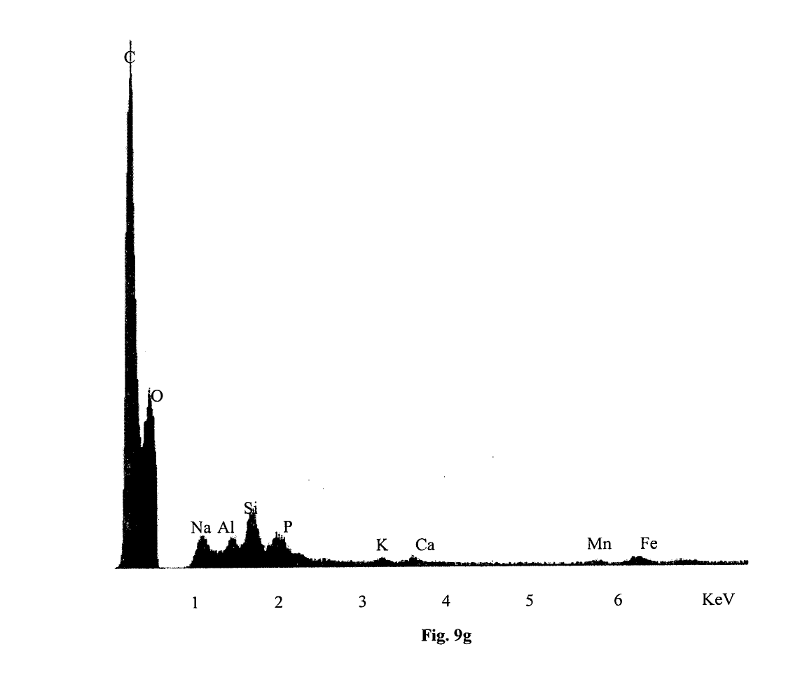

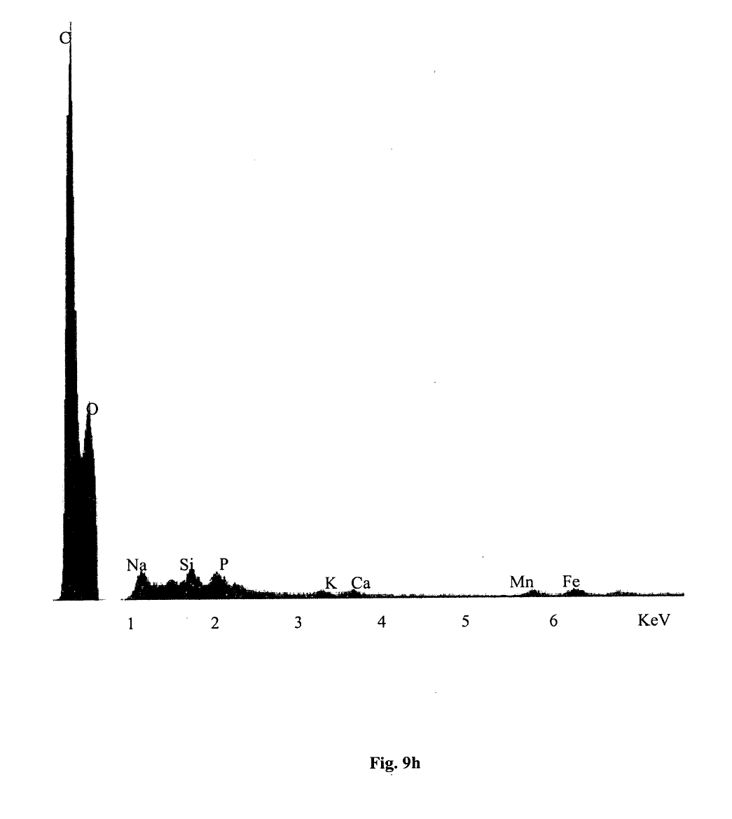

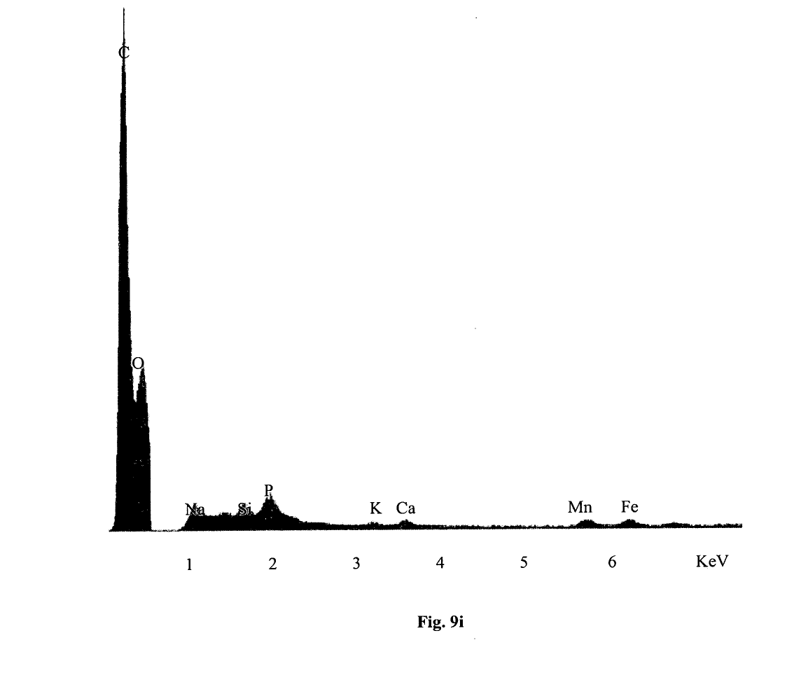

FIG. 9 shows, a TEM micrograph of the microstructure of BMC. Intermixing of the clay and minerals with the biomass and biochar can be seen. There is a high concentration of micropores and mesopores.

FIG. 9a shows another micrograph of BMC. 8 points are marked on the micrograph, for which EDX traces showing elemental composition are provided in FIGS. 9b to 9i respectively. Data for elemental compositions is shown in the table below.

| Point | C | O | Na | Mg | Al | Si | P | S | Cl | K | Ca | Mn | Fe |
|---|---|---|---|---|---|---|---|---|---|---|---|---|---|
| 1 | 30.4 | 38.6 | 0 | 0 | 4.6 | 18.3 | 3.8 | 0.4 | 0.1 | 0 | 0.9 | 0.7 | 2.2 |
| 2 | 60.6 | 27.4 | 0.3 | 0.3 | 0.3 | 0.6 | 4.5 | 0.4 | 0.2 | 0.6 | 2.2 | 2.2 | 0.4 |
| 3 | 85.8 | 12.6 | 0.3 | 0.1 | 0.1 | 0.3 | 0.3 | 0.1 | 0 | 0.1 | 0.1 | 0.1 | 0.1 |
| 4 | 86.8 | 12 | 0.3 | 0.1 | 0 | 0.2 | 0.3 | 0 | 0 | 0.2 | 0 | 0 | 0.1 |
| 5 | 85.8 | 12.1 | 0.3 | 0.1 | 0.3 | 0.7 | 0.5 | 0.1 | 0 | 0 | 0 | 0 | 0.1 |
| 6 | 82.6 | 12.9 | 0.7 | 0.5 | 0.7 | 1.4 | 0.7 | 0.1 | 0 | 0.1 | 0.1 | 0.1 | 0.1 |
| 8 | 85.5 | 12.6 | 0.4 | 0.1 | 0.1 | 0.3 | 0.6 | 0.1 | 0 | 0 | 0.1 | 0.1 | 0.1 |

### Example 12

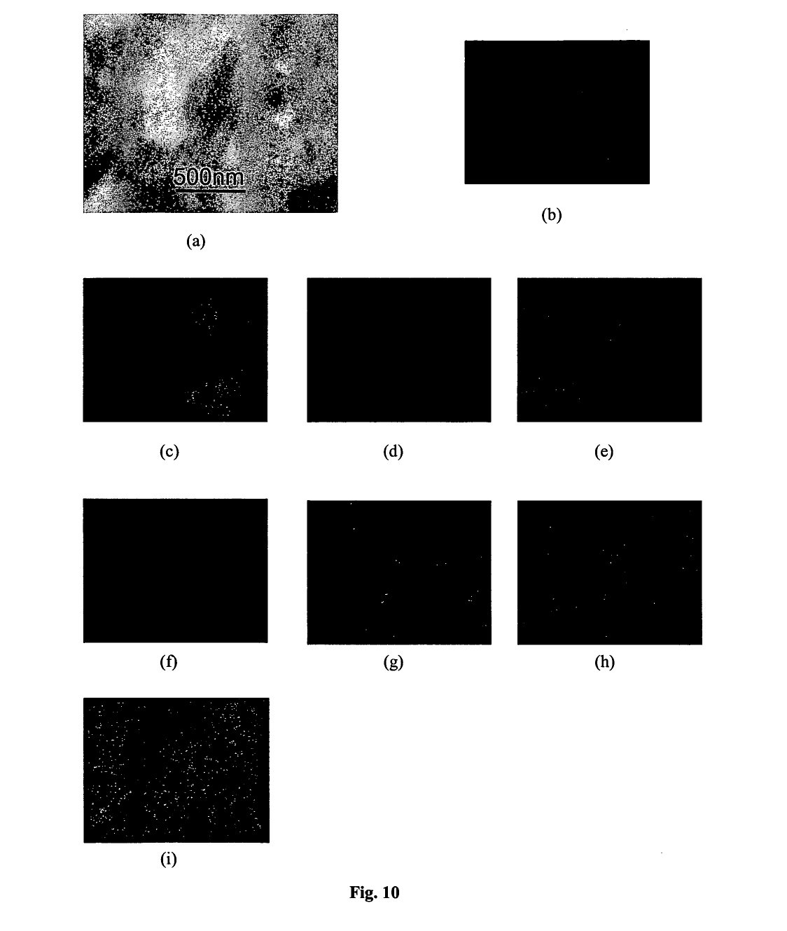

FIG. 10 shows the internal structure of a BMC. FIG. 10(a) is a TEM of the BMC and FIGS. 10(b) to 10(i) are elemental maps corresponding to calcium (FIG. 10(b), phosphorous (FIG. 10(c)), carbon (FIG. 10(d)), aluminium (FIG. 10(e)), silica (FIG. 10(f), iron (FIG. 10(g)), oxygen (FIG. 10(h)) and potassium (FIG. 10(i)). The microstructure of the BMC shows a range of mineral and carbon phases.

### Example 13

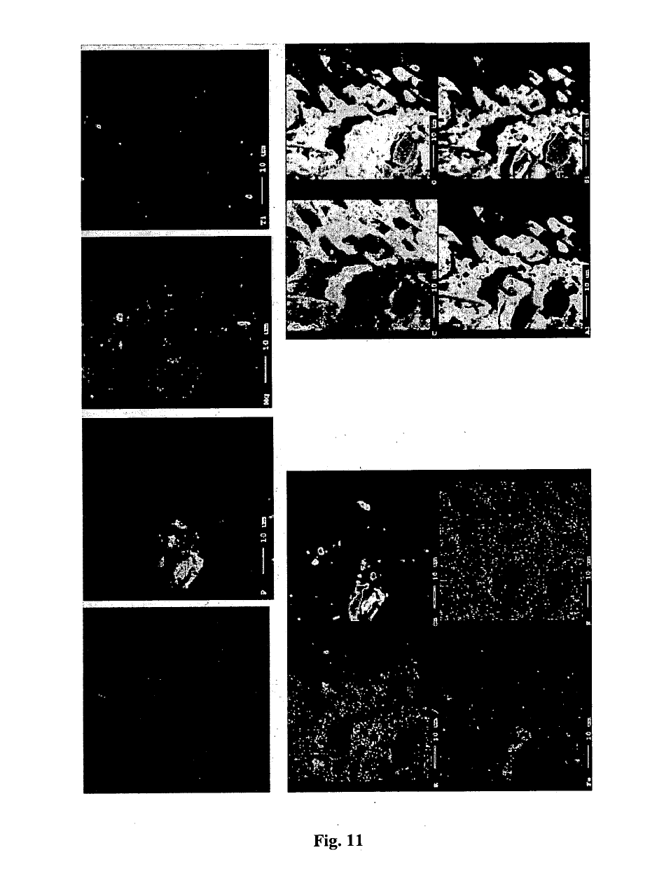

FIG. 11 shows the internal distribution of elements from a microprobe. A CaPO₄ can be seen surrounded by an amorphous carbon phase and aluminium, silica, potassium, magnesium and iron.

### Example 14

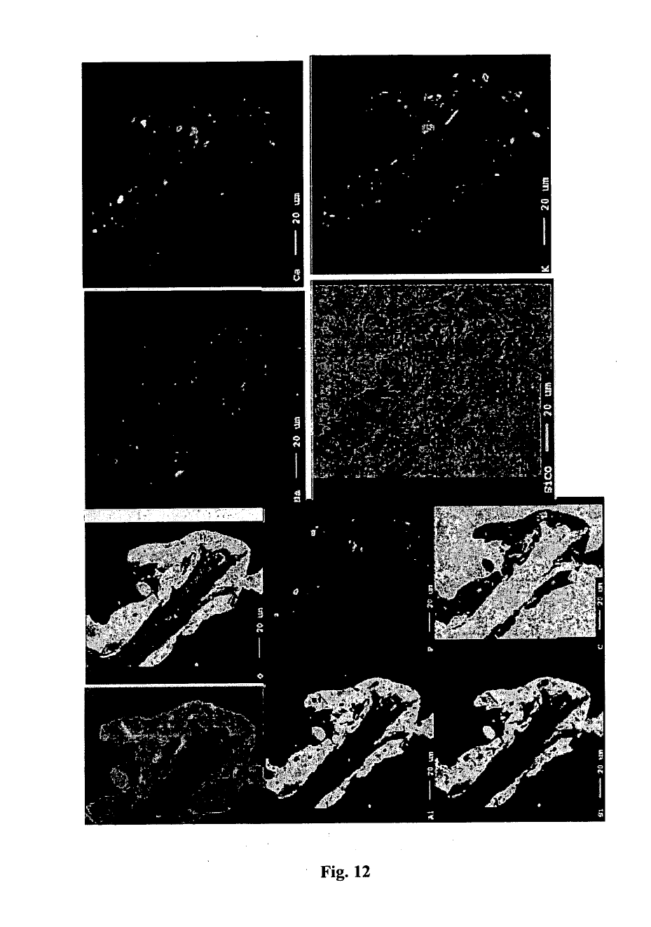

FIG. 12 shows the internal distribution of elements of wood biochar. The wood biochar is surrounded by mixed mineral matter.

### Example 15

FIG. 13 shows a test program for producing a biochar-containing composition according to the present invention. FIG. 13(a) shows mixing and heating, FIG. 13(b) shows activation of the biochar with P acid, FIG. 13(c) shows a portable kiln, FIG. 13(d) shows use of engine flue gas for torrefaction, FIG. 13(e) shows loading of the rotary kiln and FIG. 13(f) shows small pellets with biochar covered in clay and minerals cemented together by torrefied chicken litter.

### Example 16

FIG. 14 shows a 3 tonne/hour plant layout (approximate area is 100×100 m), with clay/biomass/biochar mineral mixers (310), other biomass/clay/mineral storage bins (320), 40 ft flat racks (330), torrefier (340), pyrolyser or combustor (which may be a substoichiometric combustor) (350), drier/hopper (360) and storage bins (370).

### Example 17

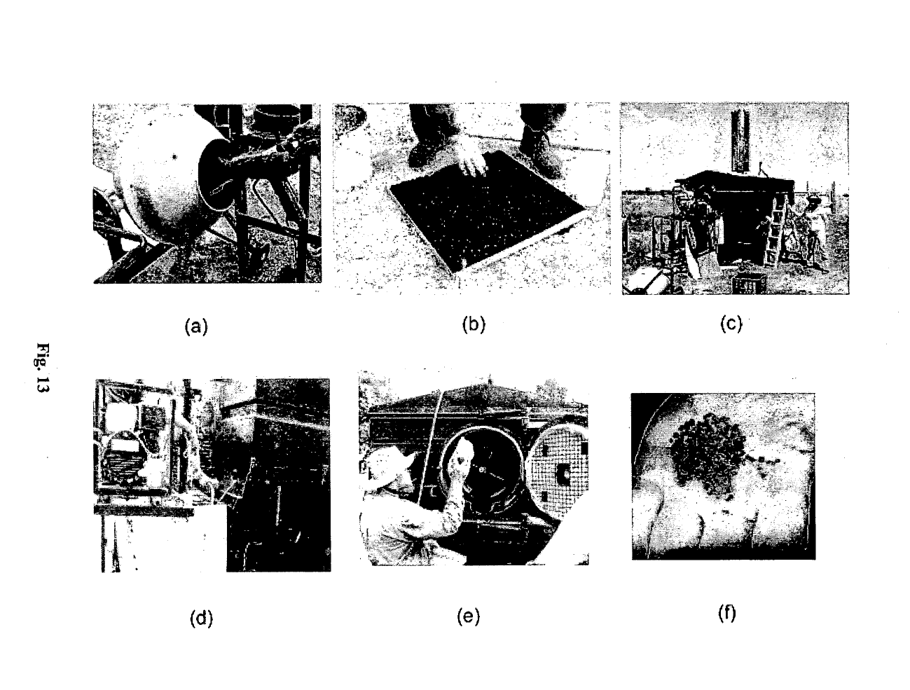

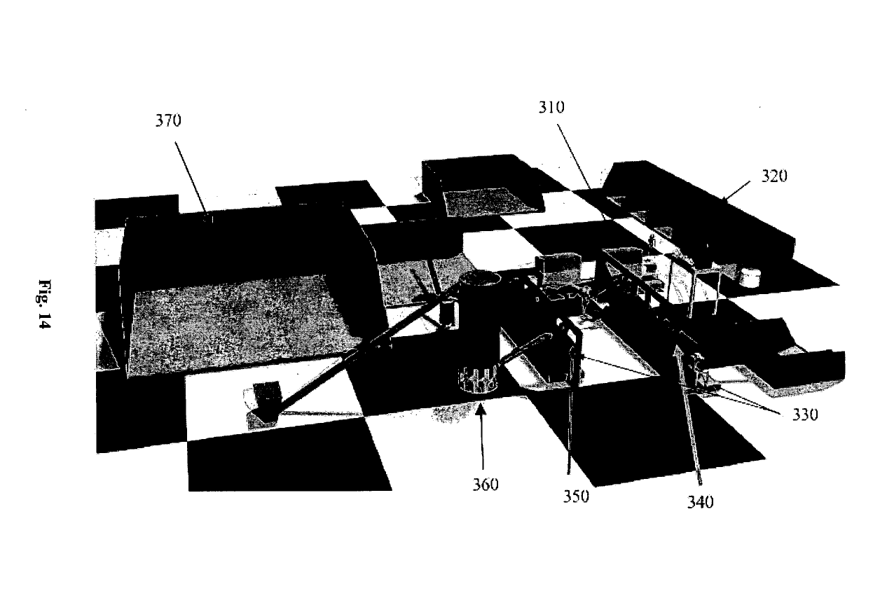

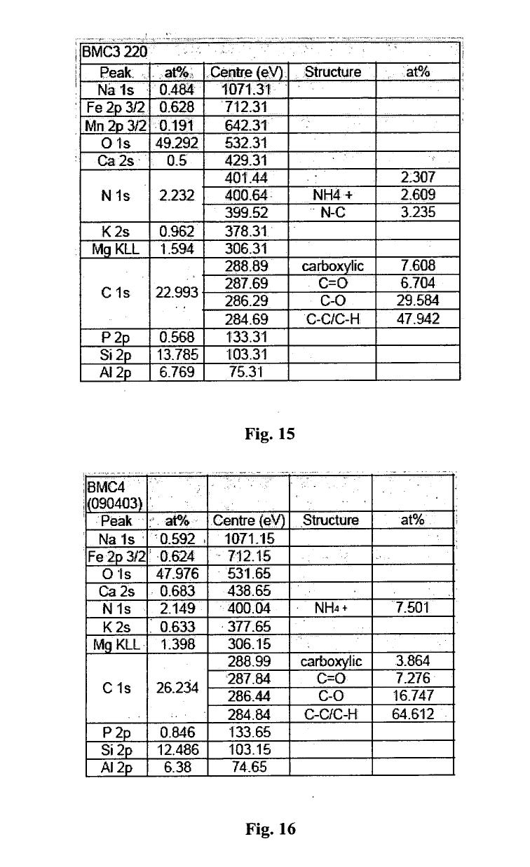

FIGS. 15 and 16 shows the results of surface characterisation by XPS of the surface elements and compounds of two BMCs. The surface of BMC has a range of functional groups that assist in nutrient retention in soil and uptake by plants. The surfaces also have a high content of organic compounds that have a high nitrogen content and polysaccharides that can be used for micro-organism development.

### Example 18

The results of functional group and solubility characterisation of the surfaces of five BMCs are shown in Table 8. The BMCs have a relatively high concentration of both acid and base oxygenated functional groups (in comparison to fresh biochar) that assist in nutrient retention in the soil and nutrient uptake by the plant. These functional groups are also involved in the absorption of dissolved organic matter, residual herbicides and pesticides and heavy metals. The concentration of these functional groups can be altered by altering the mineral content and the time and temperature regimes for pyrolysis and torrefaction.

TABLE 8

| Boehm | | | | | |
|---|---|---|---|---|---|
| Titration | | | | | |
| Result in | Total | Phenolic | Lactonic | Carboxylic | Total |
| mmol/g | Acidity | Groups | Groups | Groups | Basicity |
| BMC February | 1.609 | 0.3965 | 0.69 | 0.2795 | 1.553 |
| 2009 | | | | | |
| BMC March | 2.434 | 0.581 | 0.454 | 0.709 | 1.497 |
| 2009 | | | | | |
| BMC April | 1.812 | 0.184 | 0.846 | 0.158 | 1.756 |
| 2009 (2 + 3) | | | | | |
| BMC May | 1.451 | 0.482 | 0.3186 | 0.6662 | 1.9853 |
| 2009 ( ) | | | | | |
| BMC May | 1.6577 | 0.3537 | 0.4175 | 0.5111 | 2.113 |
| 2009 (250° C. | | | | | |
| Torrefaction) | | | | | |

### Example 19

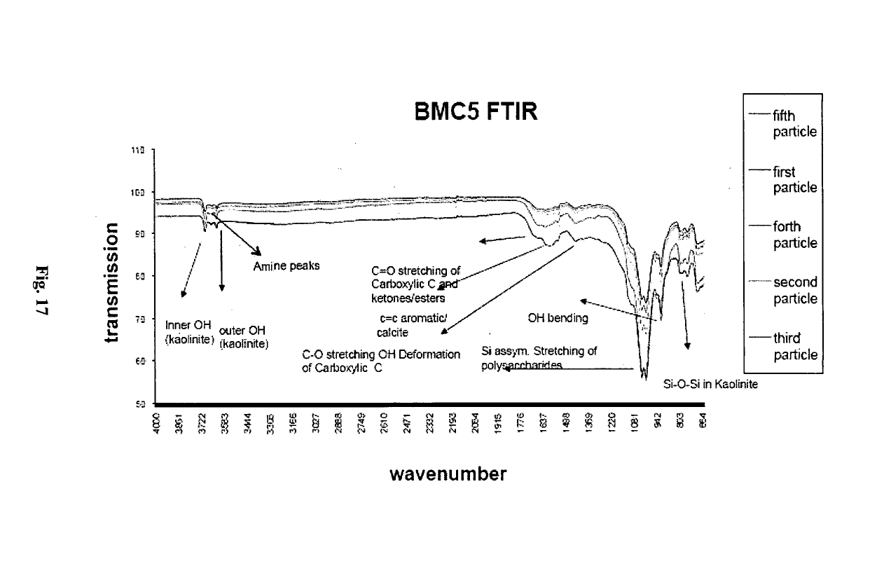

FIGS. 17 and 18 show FTIR spectra of BMC 5 and BMC 6 respectively. BMCs have a range of oxygenated functional groups that assist in nutrient retention in the soil and uptake by the plant. They also have a high content of polysaccharides that can be used for micro-organism development.

### Example 20

### Characteristic Solubility and pH

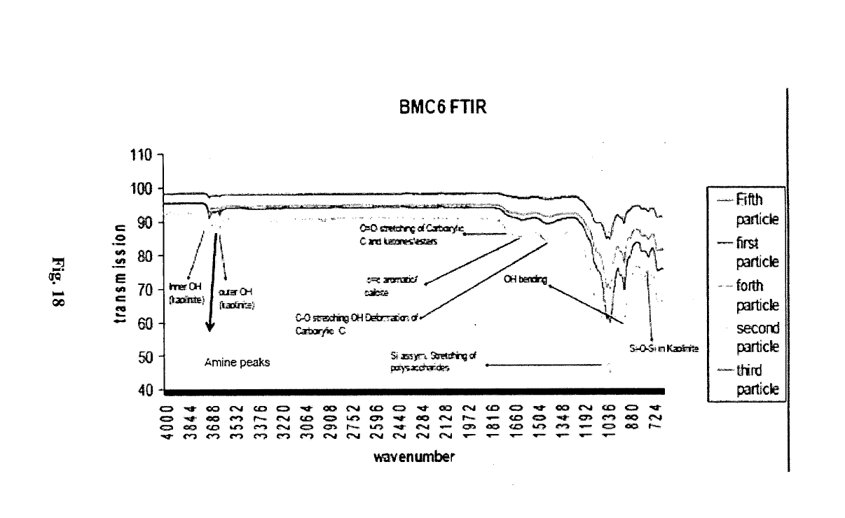

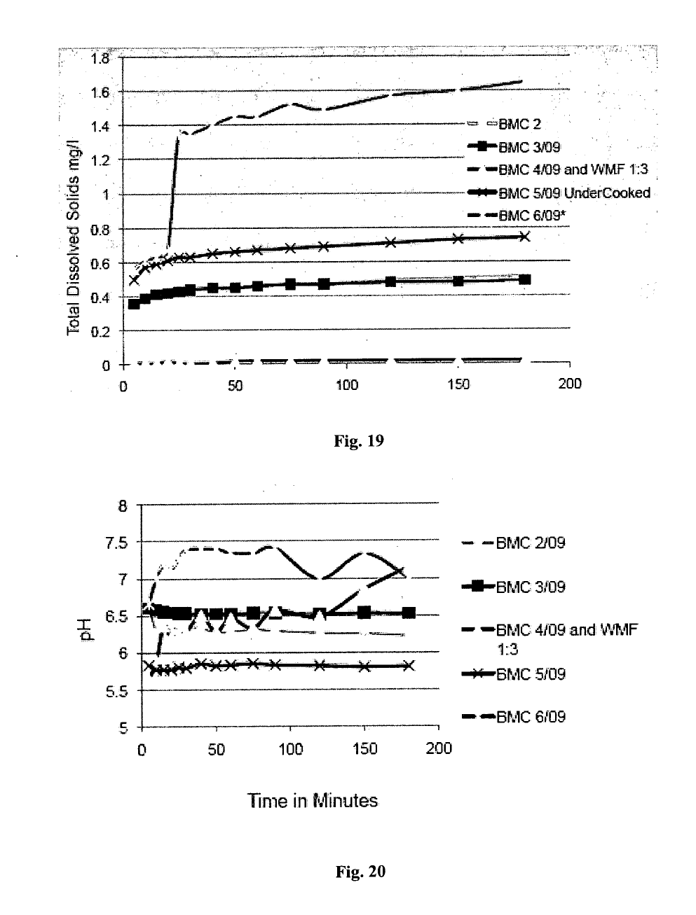

FIG. 19 is a graph of solubility of five BMCs. BMC 2 and 3 had the same composition of ingredients and were torrefied at the same temperature. They were made from Geraldton clay and local lime sands. BMC 4 (2+3) had a large component (about 75%) of Western Minerals fertiliser. BMC 5 was torrefied at about 210° C. whereas BMC2 and 3 where torrefied between 220° C. and 230° C. BMC 6 was made using clay from Tenterton and higher rock phosphate content. Heat treatment was at 250° C.

FIG. 20 is a graph of the pH of the soil around the BMC particles as a function of time. Changing the process conditions, the concentration of minerals and the type of clay can affect the rate at which the pH of the soil around the BMC particle changes and the rate at which nutrients are released.

### Example 21

### Characterisation of Labile Carbon Content of BMC

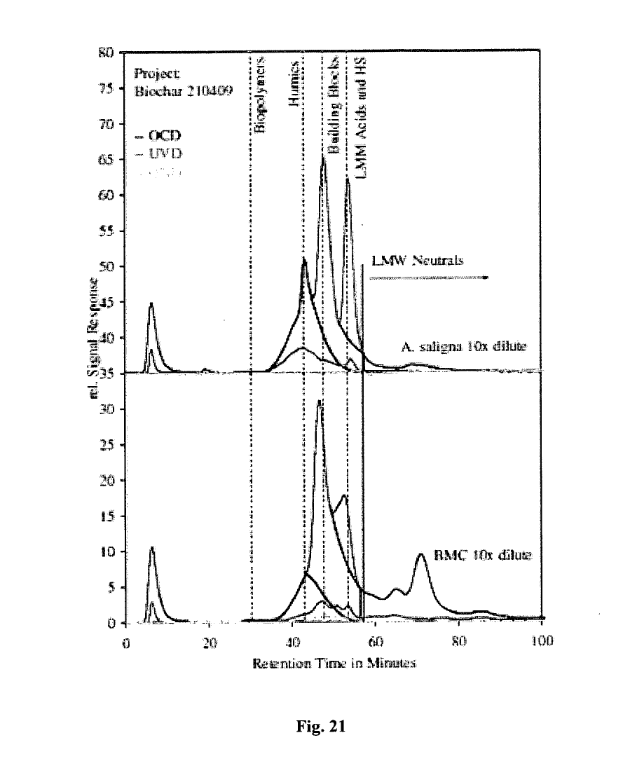

10 g of wood biochar (species A. Saligna) and 10 g of BMC were placed in 100 g of water and reacted at 30° C. for 8 hrs. The liquid was then analysed using Liquid Chromatography. The results are shown in FIG. 21.

It was determined that both biochar leachates contained very high dissolved organic carbon (DOC) concentrations of 230.9 mg L⁻¹ as C and 217.4 mg L⁻¹ as C for BMC and A. Saligna samples respectively. For both samples, the majority of the DOC was present in the form of “humics” (structures similar to fulvic and humic acids), “building blocks” (oxidation products of humics), and low molecular weight (LMW) acids (e.g. carboxylics) and humics, and LMW neutrals (uncharged small organics).

The A. Saligna contained more humic material (28.9%) than the BMC sample (20.8%) respectively. The aromaticity of the humic fraction was greater for the A. Saligna sample at 8.29 L (mg·m)⁻¹ compared with that of the BMC at 3.90 L (mg·m)⁻¹. The nitrogen concentration of the humic fraction was greater for the BMC sample (0.917 mg L⁻¹ as N) than the A. Saligna sample (0.085 mg L⁻¹ as N). There was a greater building block proportion of 37.2% for the BMC sample in comparison with the A. Saligna sample which comprised 28.4%.

### Example 22

### Characterisation of Surfaces

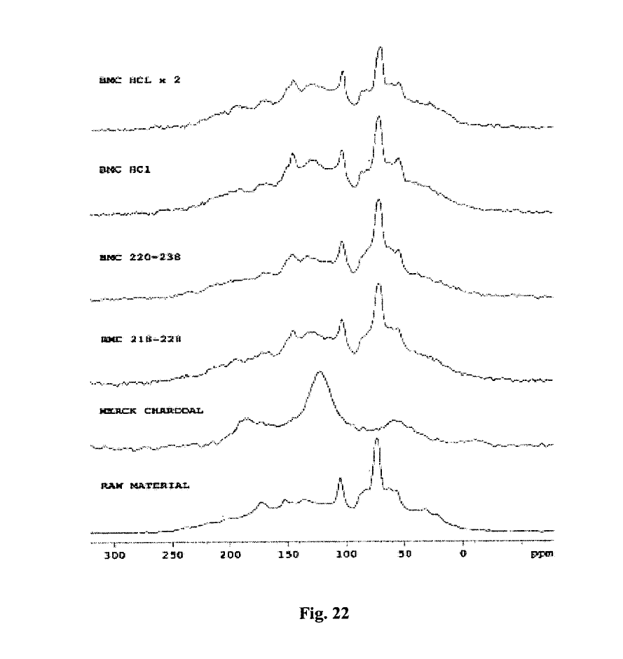

Referring to FIG. 22, NMR indicates that the structure of the BMC is significantly different to a charcoal, with a high degree of aromaticity. There is still the cellulosic structure as well as a range of aliphatic and aromatic compounds. Although the spectrum is not well resolved there is a range of O-alkyl-C, carbonyl, alkyl-C and O-aryl-C groups.

### Example 23

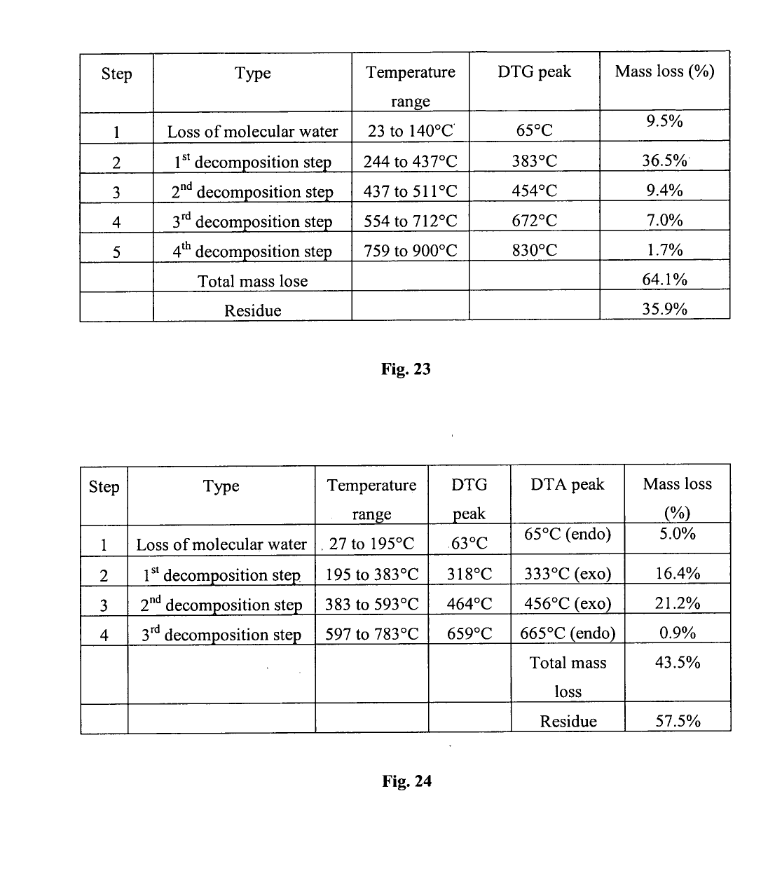

Referring to FIGS. 23 to 26, TG-MS results indicate that there is both a recalcitrant component (second decomposition peak) and a labile carbon component (first decomposition peak). It appears that the BMC has a greater percentage of recalcitrant carbon than chicken manure. The estimated lifetime of carbon in chicken manure is approximately 300 years.

### Example 24

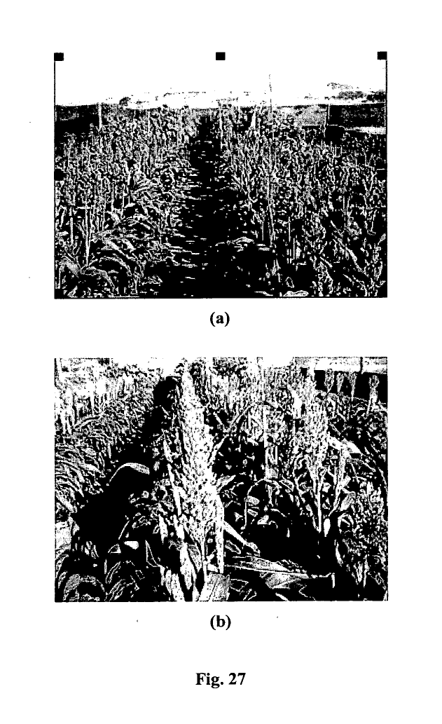

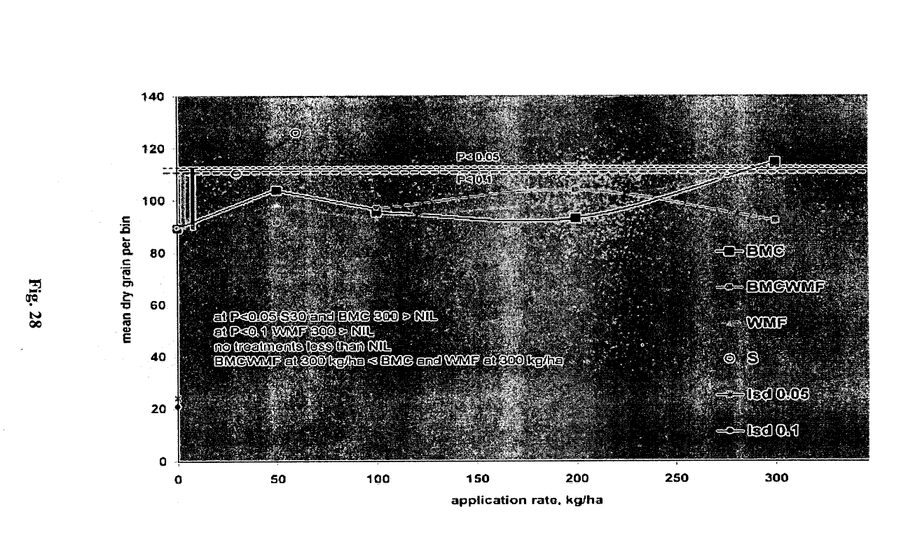

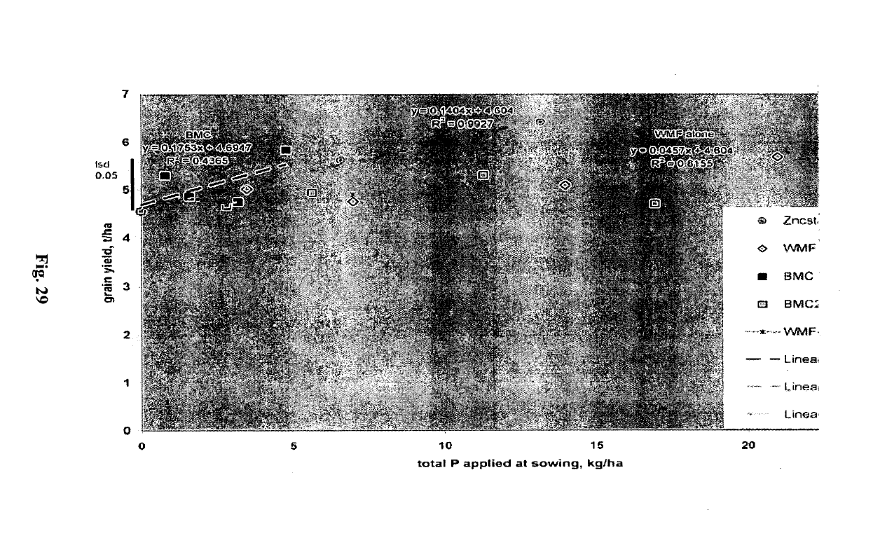

Referring to FIG. 27, initial trials were undertaken to determine the smallest amount of BMC that could significantly improve the growth of sorghum and sunflowers in a harsh summer climate. These tests were also used to develop the technique of larger pot trials in a field situation. FIG. 28 shows the grain yield per bin for rates of the different fertilisers applied to sorghum. The LSD from analysis of variance is shown for the 95% probability level (P<0.05) and 90% probability level (P<0.1) as black and red bars respectively. FIG. 29 shows the relationship between grain yield and total applied P at sowing for the different fertiliser treatments, indicating an improvement in phosphorous use. The LSD at P<0.5 is shown.

### Example 25

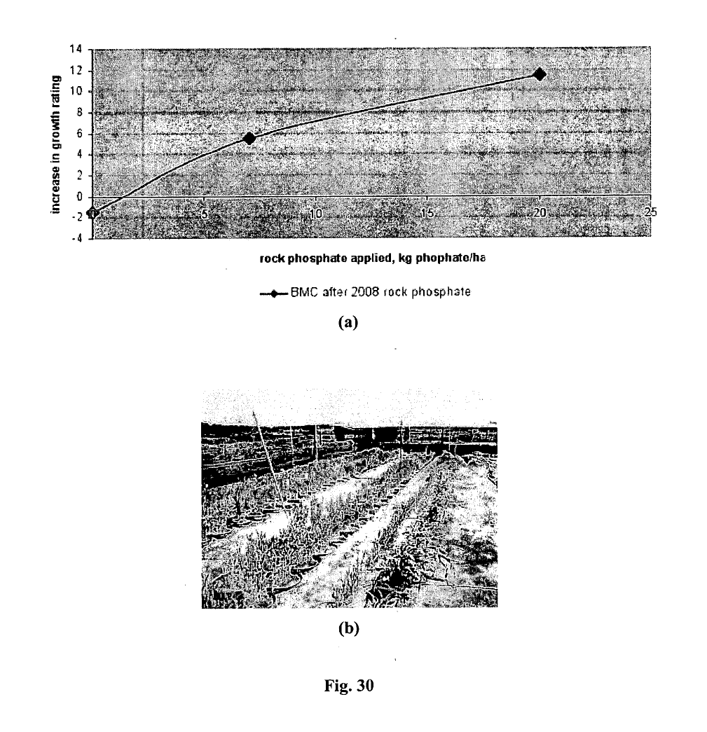

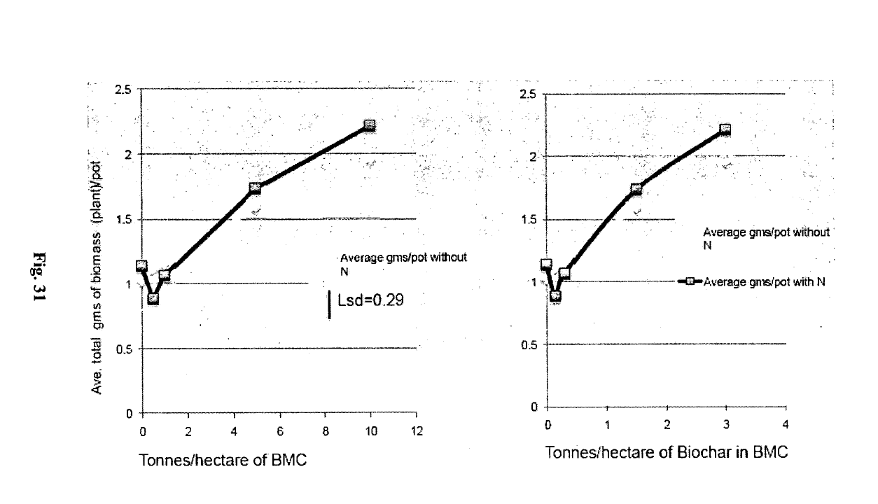

Referring to FIG. 30, following the wheat biochar trials in 2007/2008 carried out in soils that had biochar added; wheat was planted with 300 kg/ha of BMC. Rock phosphate had previously been applied before growing the wheat at different rates. FIG. 30(a) shows the growth response to BMC and rock phosphate. It can be seen that there was an improved wheat growth rating from rock phosphate by ten fold. The beneficial biology in BMC may have helped more P supply. Nutrient uptake and yield have yet to be measured.

### Example 26

FIG. 31 shows the result of wheat pot trials. A significant result is observed above 2.5 tonnes/hectare of BMC, or about 0.8 tonnes/hectare of biochar. Final results are total grams per pot (see height data for plant numbers but the target was 8 plants per pot, thinned from a sowing of 10). Dry weight percentage is simply dry weight over wet weight X100. Plants were dried at 80° C. in an agronomy shed for 5 days. N was added as urea (urea=46% N). Each pot=250 g ODE with 0.055 g urea/pot.

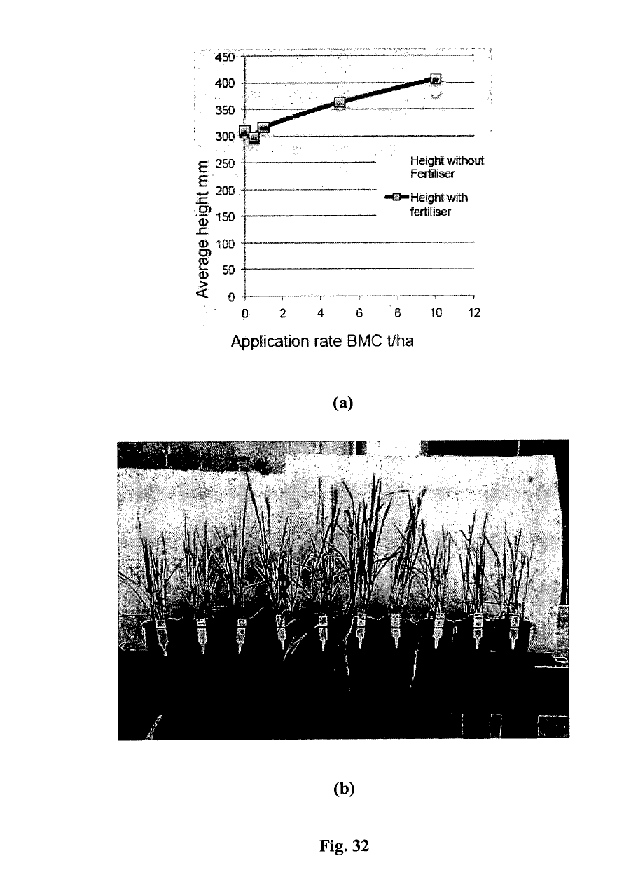

FIG. 32(a) shows the height of the wheat plants as a function of the rate of application of biochar. FIG. 32(a) are the wheat plants pre-harvest, with increasing rate of biochar towards the middle. The plants on the left had no N addition.

The results of the analysis of the soils used in the wheat pot trials prior to planting are shown in Table 9. Application of 5 tonnes/hectare of BMC to the Ferrosol soil significantly increased pH, P, C, NH₄, nitrate, CEC and reduce aluminium availability.

Analysis of the soils after harvesting of the wheat (Table 10) indicated that the application of 5 tonnes/hectare of BMC (without N) resulted in a significantly increased soil pH, P, C, NH₄, Nitrate, CEC and reduced aluminium availability. Increases were less when urea was added. It appears that nitrogen in the BMC is sufficient for increase in plant growth.

Table 11 shows the results of analysis of the N, P, K, Ca and Mg content of the wheat. Mineral content of the wheat from the 5 t/ha of BMC (except for calcium) was higher than for the control. Addition of urea increased nitrogen content in the wheat grown without BMC and for 5 t/ha. For the higher application rates of BMC there was not a significant difference to plants grown with and without urea. It appears that the extra yield of wheat from the addition of BMC was at the expense of nitrogen in the plant.

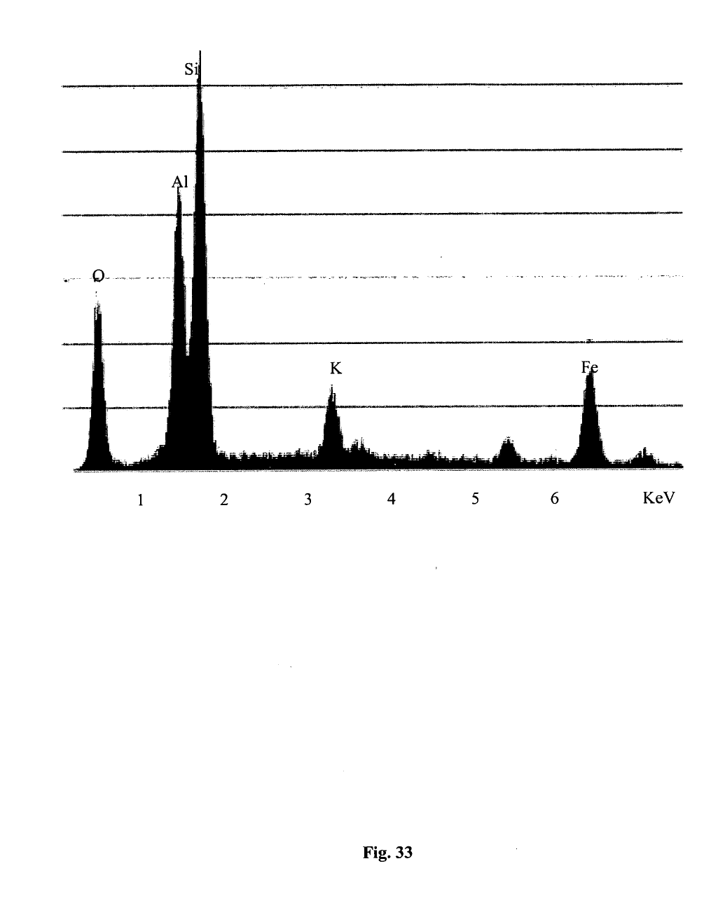

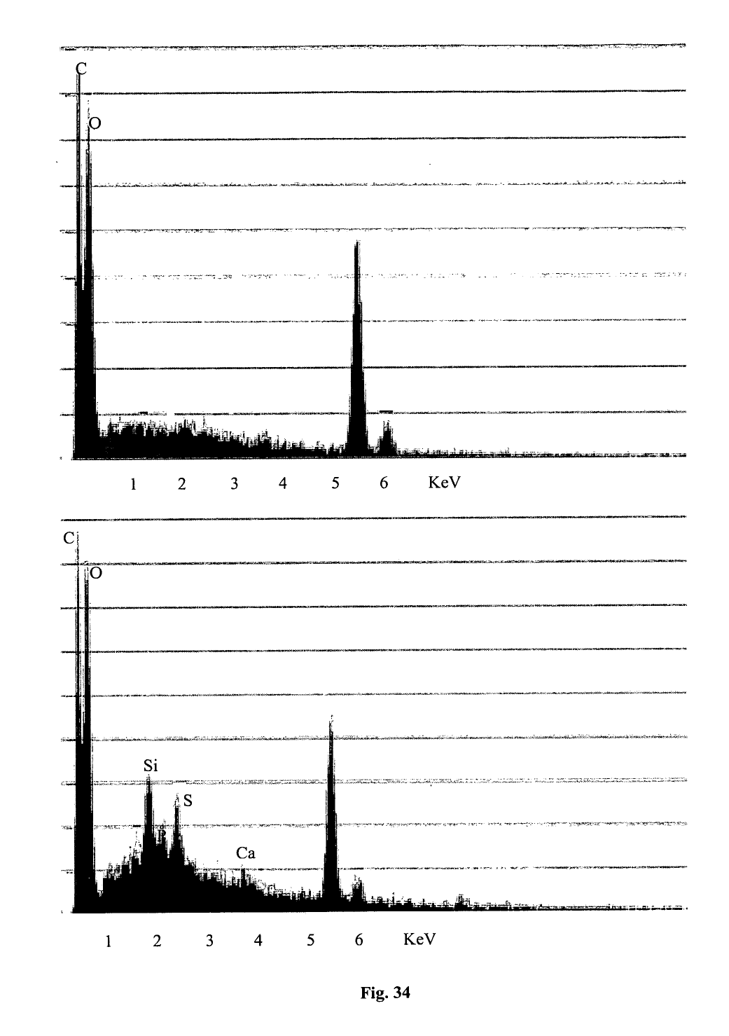

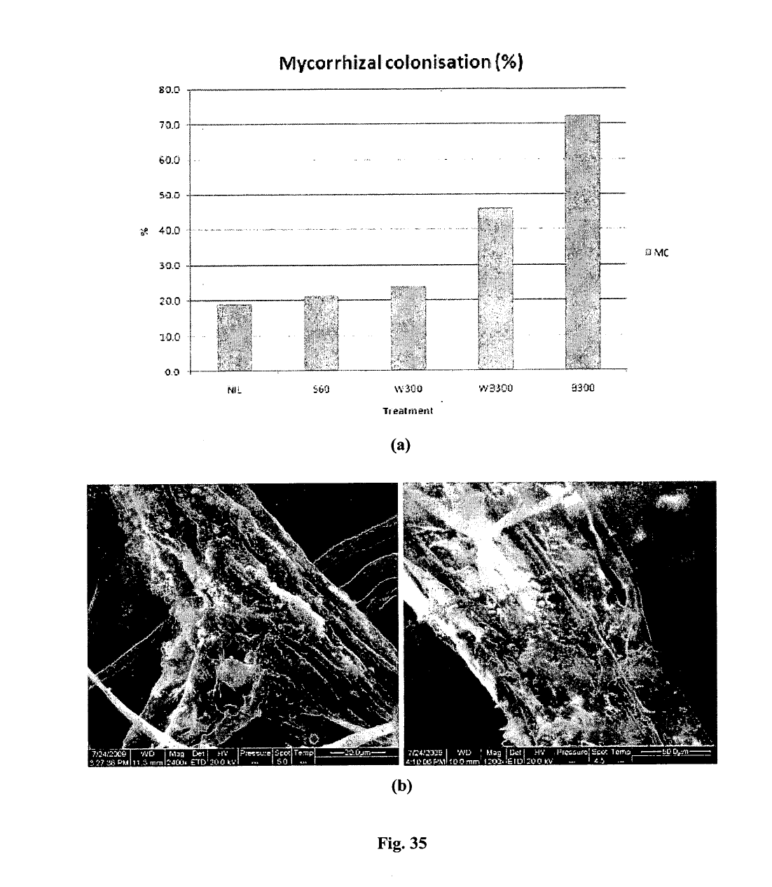

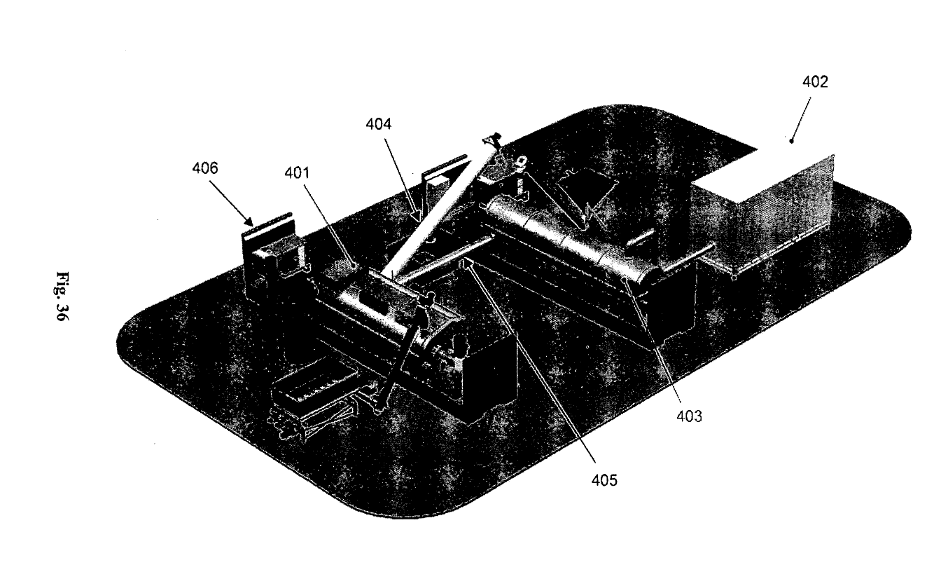

FIG. 33 shows an agglomerate particle attached to the roots of a plant from the pot trials. The agglomerate could be BMC coated in clay. FIG. 34 shows an improvement in phosphorus use and FIG. 35 shows an improvement in fungi growth. In FIG. 35 S means water soluble fertiliser, W means WMF, WB means 75% WMF/25% BMC and B means BMC.

TABLE 9

| | | | BMC | | | | |
|---|---|---|---|---|---|---|---|
| | | Limit of | 2/3 | BMC | BMC | BMC | BMC |
| | Unit | Reporting | Control | 500 kg/ha | 1 t/ha | 5 t/ha | 10 t/ha |
| EC | Ds/m | 0.01 | 0.17 | 0.16 | 0.18 | 0.23 | 0.28 |
| pH (CaCl₂) | | 0.04 | 4.3 | 4.5 | 4.5 | 4.6 | 4.6 |
| Bray P | mg/kg | 0.06 | 4.9 | 3.1 | 3.3 | 6.6 | 12 |
| Colwell P | mg/kg | 2 | 34 | 26 | 29 | 43 | 52 |
| Total N | % | 0.02 | 0.48 | 0.45 | 0.46 | 0.48 | 0.48 |
| Total C | % | 0.20 | 4.7 | 4.4 | 4.5 | 4.7 | 4.9 |
| KCl | mg/kg | 0.3 | 2.6 | 3.6 | 3.7 | 3.5 | 3.3 |
| Extractable | | | | | | | |
| NH₄ | | | | | | | |
| KCl | mg/kg | 0.2 | 81 | 77 | 83 | 100 | 120 |
| Extractable | | | | | | | |
| Nitrate | | | | | | | |
| Moisture | % | 0.1 | 21 | 23 | 21 | 22 | 22 |
| Exchangeable | | | | | | | |
| Cations | | | | | | | |
| Aluminium | cmol(+)/kg | 0.034 | 0.11 | 0.057 | 0.063 | 0.070 | 0.056 |
| Calcium | cmol(+)/kg | 0.013 | 4.2 | 4.4 | 4.4 | 5.1 | 6.9 |
| Potassium | cmol(+)/kg | 0.085 | <0.085 | <0.085 | <0.085 | 0.13 | 0.26 |
| Magnesium | cmol(+)/kg | 0.003 | 0.86 | 0.85 | 0.88 | 1.0 | 1.4 |
| Manganese | cmol(+)/kg | 0.001 | 0.062 | 0.061 | 0.065 | 0.072 | 0.080 |
| Sodium | cmol(+)/kg | 0.037 | 0.062 | 0.054 | 0.067 | 0.16 | 0.34 |

TABLE 10

| | | Limit of | | | BMC | BMC | BMC |
|---|---|---|---|---|---|---|---|
| | Unit | Reporting | Control | Control + N | 0.5 t/ha | 0.5 t/ha | 1 t/ha |
| EC | Ds/m | 0.01 | 0.095 | 0.091 | 0.066 | 0.065 | 0.071 |
| pH (CaCl₂) | | 0.04 | 4.4 | 4.2 | 4.4 | 4.4 | 4.5 |
| Bray P | mg/kg | 0.06 | 5.2 | 7.1 | 5.1 | 5.5 | 4.9 |
| Total N | % | 0.02 | 0.45 | 0.49 | 0.43 | 0.44 | 0.45 |
| Total C | % | 0.20 | 4.4 | 4.6 | 4.3 | 4.3 | 4.4 |
| KCl | mg/kg | 0.3 | 4.7 | 3.4 | 4.5 | 5.5 | 5.7 |
| Extractable | | | | | | | |
| NH₄ | | | | | | | |
| KCl | mg/kg | 0.2 | 19 | 22 | 10 | 11 | 8.9 |
| Extractable | | | | | | | |
| Nitrate | | | | | | | |
| Organic | % | 0.05 | 4.1 | 4.2 | 4.2 | 4.1 | 4.0 |
| Carbon | | | | | | | |
| Exchangeable | | | | | | | |
| Cations | | | | | | | |
| Aluminium | cmol(+)/kg | 0.01 | 0.18 | 0.33 | 0.18 | 0.24 | 0.14 |
| Calcium | cmol(+)/kg | 0.01 | 4.0 | 3.5 | 4.0 | 3.6 | 3.9 |
| Potassium | cmol(+)/kg | 0.02 | 0.14 | 0.15 | 0.13 | 0.14 | 0.13 |
| Magnesium | cmol(+)/kg | 0.008 | 0.89 | 0.81 | 0.84 | 0.74 | 0.87 |
| Sodium | cmol(+)/kg | 0.02 | 0.37 | 0.32 | 0.33 | 0.27 | 0.35 |
| CEC | cmol(+)/kg | | 5.6 | 5.1 | 5.5 | 5.0 | 5.4 |

| | | Limit of | BMC | BMC | BMC | BMC | BMC |
|---|---|---|---|---|---|---|---|
| | Unit | Reporting | 1 t/ha + N | 5 t/ha | 5 t/ha + N | 10 t/ha | 10 t/ha + N |
| EC | Ds/m | 0.01 | 0.063 | 0.073 | 0.069 | 0.079 | 0.071 |
| pH (CaCl₂) | | 0.04 | 4.4 | 4.7 | 4.5 | 4.9 | 4.7 |
| Bray P | mg/kg | 0.06 | 5.6 | 7.3 | 9.1 | 12 | 11 |
| Total N | % | 0.02 | 0.45 | 0.48 | 0.46 | 0.46 | 0.47 |
| Total C | % | 0.20 | 4.4 | 4.8 | 4.7 | 5.5 | 4.7 |
| KCl | mg/kg | 0.3 | 4.6 | 4.5 | 5.9 | 6.5 | 7.5 |
| Extractable | | | | | | | |
| NH₄ | | | | | | | |
| KCl | mg/kg | 0.2 | 8.3 | 8.0 | 6.1 | 6.0 | 6.0 |
| Extractable | | | | | | | |
| Nitrate | | | | | | | |
| Organic | % | 0.05 | 4.0 | 4.3 | 4.2 | 4.3 | 4.4 |
| Carbon | | | | | | | |
| Exchangeable | | | | | | | |
| Cations | | | | | | | |
| Aluminium | cmol(+)/kg | 0.01 | 0.20 | 0.076 | 0.12 | 0.038 | 0.054 |
| Calcium | cmol(+)/kg | 0.01 | 3.7 | 4.7 | 4.4 | 5.6 | 5.1 |
| Potassium | cmol(+)/kg | 0.02 | 0.13 | 0.13 | 0.14 | 0.14 | 0.14 |
| Magnesium | cmol(+)/kg | 0.008 | 0.77 | 0.95 | 0.87 | 1.0 | 0.98 |
| Sodium | cmol(+)/kg | 0.02 | 0.29 | 0.39 | 0.37 | 0.42 | 0.39 |
| CEC | cmol(+)/kg | | 5.1 | 6.2 | 5.9 | 7.2 | 6.7 |

TABLE 11

| | | Limit of | | | BMC | BMC | BMC |
|---|---|---|---|---|---|---|---|
| | Unit | Reporting | Control | Control + N | 0.5 t/ha | 0.5 t/ha | 1 t/ha |
| Total | % | 0.02 | 1.5 | 1.9 | 1.4 | 1.7 | 1.2 |
| Nitrogen | | | | | | | |
| Calcium | % | 0.0003 | 0.49 | 0.51 | 0.51 | 0.49 | 0.51 |
| Potassium | % | 0.0004 | 1.2 | 1.3 | 0.98 | 1.3 | 1.1 |
| Magnesium | % | 0.00006 | 0.16 | 0.18 | 0.18 | 0.16 | 0.16 |
| Phosphorus | % | 0.003 | 0.17 | 0.14 | 0.15 | 0.12 | 0.18 |

| | | Limit of | BMC | BMC | BMC | BMC | BMC |
|---|---|---|---|---|---|---|---|
| | Unit | Reporting | 1 t/ha + N | 5 t/ha | 5 t/ha + N | 10 t/ha | 10 t/ha + N |
| Total | % | 0.02 | 1.3 | 1.5 | 1.3 | 1.5 | 1.5 |
| Nitrogen | | | | | | | |
| Calcium | % | 0.0003 | 0.46 | 0.46 | 0.45 | 0.36 | 0.37 |
| Potassium | % | 0.0004 | 1.2 | 1.2 | 1.3 | 1.4 | 1.3 |
| Magnesium | % | 0.00006 | 0.15 | 0.18 | 0.16 | 0.17 | 0.17 |
| Phosphorus | % | 0.003 | 0.14 | 0.20 | 0.22 | 0.24 | 0.24 |

### Example 27

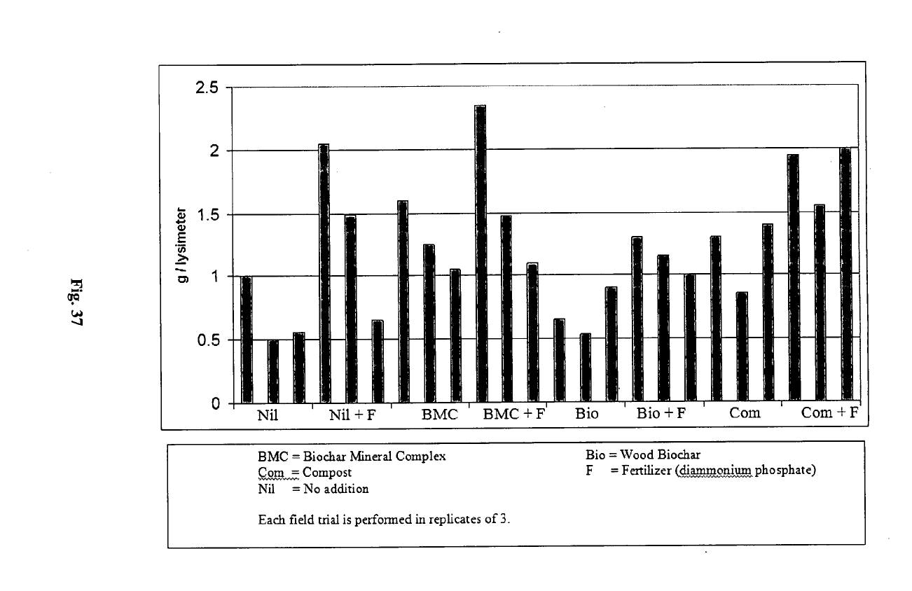

FIG. 36 shows a biochar mineral complex plant, with pyrolysis kiln (401), bio filter (402), torrefier (403), hot gas conduit (404), material transfer conduit (405) and gas scrubber (406). Kiln 401 may be a 3-stage combuster. In the first stage of the combuster a low oxygen atmosphere may be used for controlled oxidation. Thus in use heated air may be injected into the first stage at a sub-stoichiometric level. Thus the three stages are: 1) air injection into the main chamber, 2) air injection as hot gases exit the chamber, and 3) the main oxidiser.

### Example 28

This experiment is based on a report prepared by Richard Devlin for Western Mineral Fertilisers, and represents an assessment of WMF NPK Crop Plus, NPK Crop B and WMF Ag. Microbes on Wheat Yield and Quality.

One trial was conducted at Bruce Rock, Western Australia to evaluate the effect on wheat (cv. Bonnie Rock) yield and quality from applying Westem Mineral Fertiliser's NPK Crop Plus or NPK Crop B plus W.M.F. Ag Microbes. NPK Crop B comprised NPK Crop Plus (75%) and a biochar mineral complex (25%). These were compared to a “standard” non-mineral program. In this trial the standard used was C.S.B.P.'s Macro Pro extra which had been treated with Intake-in-Furrow fungicide (250 g/l Flutriafol). Vigour was greatest in plots which had received post-emergent Nitrogen. This did not translate into yield differences, with no significant differences in yield between any plots. Despite the differences in applied nitrogen there was also no significant difference in protein or hectolitre weights between any of the treatments. Tissue test analysis was also undertaken and showed nutrient levels as generally lower in the Untreated Control/No Fertiliser plots. There were no major differences in nutrients between the treatments. Last season's experimental fertiliser application appeared to have little effect on this season's vigour, yield or quality results.

The aim of the work was to investigate the effect on wheat yield and quality of using 70 kg/ha of WMF's NPK Crop Plus and NPK Crop B, with and without WMF's Microbe fertiliser treatment and addition of extra nitrogen. Additionally, plots were sown over last year's trial plots to assess whether there was any residual effect from the previous year's fertiliser application.

Treatments were as follows:

TABLE 12
Treatment names, products and rates used in trials

| | | | | N |
|---|---|---|---|---|
| | | Microbes/ | Nitrogen | application |
| Treatment | Base Fertiliser | Other | (UAN) | timing |
| 1 | 70 kg/ha WMF | +7S0 g/t Ag | None | None |
| | Crop Plus | Microbes on | | |
| | | seed | | |
| 2 | 70 kg/ha WMF | +750 g/t Ag | 10.5 units | 4 WAS |
| | NPK Crop B | Microbes on | granular | (weeks after |
| | | seed | Urea | sowing) |
| 3 | 70 kg/ha WMF | +750 g/t Ag | 10.5 units | 4 WAS |
| | Crop Plus | Microbes on | granular | |
| | | seed | Urea | |
| 4 | Untreated Control | — | — | — |
| | (UTC) | | | |
| 5 | 70 kg/ha Macro | 400 ml/ha | None | None |
| | Pro Extra | Impact in | | |
| 6 | 70 kg/ha Macro | 400 ml/ha | 10.5 units | 4 WAS |
| | Pro Extra | Impact in | granular | |
| | | Furrow | Urea | |
| | 70 kg/ha WMF | +750 g/t Ag | None | None |
| | NPK Crop B | Microbes on | | |

TABLE 13
Typical analysis of fertiliser used in trial

| | Typical Analysis | | | | | | | | |
|---|---|---|---|---|---|---|---|---|---|
| Fertiliser | N | P | K | S | Ca | Mg | Fe | Cu | Zn |
| NPK Crop | 8 | 9 | 4.5 | 7.6 | — | 1.3 | 2 | — | — |
| Plus | | | | | | | | | |
| NPK Crop B | 6 | 6.75 | 3.4 | 5.7 | 4.3 | 0.7 | 1.5 | | |
| Macro Pro | 9.7 | 11.2 | 11.2 | 10.2 | — | — | — | 0.1 | 0.2 |
| Extra | | | | | | | | | |
| UAN (% w/v) | 42 | — | — | — | — | — | — | — | — |

Experimental details were as follows:
Study Design: Complete randomised block
Treatments: 7
Replications: 3
Plot Length: 10.4 m
Plot Width: 1.25 m

Site details were as follows:
Location: Cramphorne Road, Bruce Rock
Soil Description: Gravelly Loam
Paddock History:
2008 Wheat
2007 Lupins
2006 Wheat

Crop and sowing details were:
Date Sown: Jun. 6, 2009
Variety: Bonnie Rock
Seeding Rate: 65 kg/ha
Nutrition: As per treatment design
Tillage Type: Primary Sales Knife points and Press wheels
Seed Bed: Even. Untilled
Moisture: Marginal moisture
Row Spacing: 9 inch
Herbicides Applied: Pre-sowing: 2.5 L/ha Trifluralin and 2 L/ha SpraySeed and 500 ml/ha Diuron
   Post sowing 26 Jul. 7, 2009 500 ml/ha Crusader, 800 ml/ha Bromicide MA; Dec. 8, 2009 380 g/ha Achieve+1% Supercharge.
Insecticides Applied: Pre sowing: none
   Post sowing: none
Fungicides Applied: Pre sowing: none
   Post sowing: none

### Application Details

Despite the differences in analysis between the W.M.F NPK Crop Plus, W.M.F NPK Crop B and the Macro Pro Extra, the rates of each fertiliser were kept the same (70 kg/ha). Macro Pro Extra was chosen as the comparison as it is a widely used compound fertiliser in Western Australia. Intake-in-furrow is (250 g/l Flutriafol) a commonly used fungicide used for suppression of rusts and Septoria in wheat. It was applied to the Macro Pro Extra prior to sowing to give an application rate of 400 ml/ha. Seed and fertiliser were applied via a dedicated small plot seeder at sowing. Seed and fertiliser were split with fertiliser being banded at the bottom of the furrow approximately 3-4 cm from the seed.

Post emergent Nitrogen (granular urea) was applied on the Sep. 7, 2009 at crop growth stage Z 21. This trial was sown on top of the 2009 trial. Table 14 shows the 2008 and 2009 treatments.

TABLE 14
2008 treatment list. 2009 treatments were sown over the top of the 2008 plots.

| | | | | | N |
|---|---|---|---|---|---|
| | | | | | application |
| Treatment | Year | Base Fertiliser | Microbes/Other | Nitrogen | timing |
| 1 | 2009 | 70 kg/ha WMF | +750 g/t Ag | None | None |
| | | Crop Plus | Microbes on seed | | |
| | 2008 | 100 kg/ha WMF | +750 g/t Ag | None | None |
| | | Crop Plus | Microbes on seed | | |
| 2 | 2009 | 70 kg/ha WMF | +750 g/t Ag | 10.5 units | 4 WAS |
| | | NPK Crop B | Microbes on seed | granular | (weeks |
| | | | | urea | after |
| | | | | | sowing) |
| | 2008 | 100 kg/ha WMF | +750 g/t Ag | 10.5 units | At Sowing |
| | | Crop Plus | Microbes on seed | Liquid N | |
| 3 | 2009 | 70 kg/ha WMF | +750 g/t Ag | 10.5 units | 4 WAS |
| | | Crop Plus | Microbes on seed | granular | |
| | | | | urea | |
| | 2008 | 100 kg/ha WMF | +750 g/t Ag | 10.5 units | 50 DAS |
| | | Crop Plus | Microbes on seed | Liquid N | (days after |
| | | | | | sowing) |
| 4 | 2009 | Untreated Control | — | — | — |
| | | (UTC) | | | |
| | 2008 | 100 kg/ha Macro | 400 ml/ha Impact in | None | None |
| | | Pro Extra | Furrow | | |
| 5 | 2009 | 70 kg/ha Macro | 400 ml/ha Impact in | None | None |
| | | Pro Extra | Furrow | | |
| | 2008 | 100 kg/ha Macro | 400 ml/ha Impact in | 10.5 units | At Sowing |
| | | Pro Extra | Furrow | Liquid N | |
| 6 | 2009 | 70 kg/ha Macro | 400 ml/ha Impact in | 10.5 units | 4 WAS |
| | | Pro Extra | Furrow | granular | |
| | | | | urea | |
| | 2008 | 100 kg/ha Macro | 400 ml/ha Impact in | 10.5 units | 50 DAS |
| | | Pro Extra | Furrow | Liquid N | |
| 7 | 2009 | 70 kg/ha WMF | +750 g/t Ag | None | None |
| | | NPK Crop B | Microbes on seed | | |
| | 2008 | 100 kg/ha WMF | No Microbes | None | None |
| | | Crop Plus | | | |

Assessment details were:

### Plant Vigour

Plot plant vigour was assessed on the on 20 Sep. 2009. Whole plot vigour was rated on a scale of 1-10 where 1=very poor and 10=excellent vigour/biomass.

### Plant Tissue Analysis

A representative sample of whole plant tops taken from each treatment on the 5 Aug. 2009.

Note: composite samples consist of 4 plants per treatment per repetition which are combined to form one sample for analysis. All samples were sent for comprehensive plant analysis at CSBP laboratories, Perth.

### Harvest

All plots were harvested with a Hege 125C small plot combine. Individual grain weight was taken from each plot.

### Quality

Individual grain sample was taken for each treatment and analysed for protein, screenings and hectolitre weight at Co-Operative Bulk Handling, Northam.

### Statistical Analysis and Discussion

TABLE 15
Assessment Results. Means followed by same letter do not significantly differ
(P = .05, Duncan's New MRT—multiple range test). Mean comparisons
performed only when AOV (analysis of variance) Treatment P(F) is significant at
mean comparison OSL.

| | | Vigour | Yield | | | |
|---|---|---|---|---|---|---|
| Treatment | | 20/09/09 | t/ha | Protein % | Hectolitre | Screenings % |
| 1 | 70 kg/ha NPK Crop | 4.0 bb | 1.607 bb | 10.40 ab | 77.413 a | 2.973 c |
| | Plus; 750 g/t WMF | | | | | |
| | Microbes on Seed; | | | | | |
| | NO Nitrogen | | | | | |
| 2 | 70 kg/ha NPK Crop B; | 5.7 a | 1.580 abc | 10.80 a | 77.677 a | 4.263 a |
| | 750 g/t WMF | | | | | |
| | Microbes on Seed; | | | | | |
| | 27.5 kg/ha Granular | | | | | |
| | Urea | | | | | |
| 3 | 70 kg/ha NPK Crop | 5.3 a | 1.457 bc | 10.50 ab | 77.110 a | 3.780 ab |
| | Plus; 750 g/t WMF | | | | | |
| | Microbes on Seed; | | | | | |
| | 27.5 kg/ha Granular | | | | | |
| | Urea | | | | | |
| 4 | NO Starter Fertiliser; | 3.7 c | 1.307 c | 10.20 b | 78.907 a | 2.247 c |
| | NO Microbes; NO | | | | | |
| | Nitrogen | | | | | |
| 5 | 70 kg/ha Macro Pro; | 5.3 a | 1.777 a | 10.23 b | 80.020 a | 2.633 c |
| | 400 mls/ha Intake-in- | | | | | |
| | furrow; NO Nitrogen | | | | | |
| 6 | 70 kg/ha Macro Pro; | 6.0 a | 1.715 ab | 10.73 a | 78.413 a | 3.023 bc |
| | 400 mls/ha Intake-in- | | | | | |
| | furrow; 27.5 kg/ha | | | | | |
| | Granular Urea | | | | | |
| 7 | 70 kg/ha NPK Crop B; | 5.0 ab | 1.467 bc | 10.87 a | 78.693 a | 2.497 c |
| | 750 g/t WMF | | | | | |
| | Microbes on Seed; | | | | | |
| | NO Nitrogen | | | | | |

| | | | | | |
|---|---|---|---|---|---|
| LSD (P = .05) | 1.24 | 0.2814 | 0.436 | 2.6831 | 0.7586 |
| Standard Deviation | 0.7 | 0.1582 | 0.245 | 1.5081 | 0.4264 |
| CV | 13.92 | 10.29 | 2.33 | 1.93 | 13.94 |
| Bartlett's X2 | 1.524 | 1.889 | 5.994 | 12.354 | 5.886 |
| P(Bartlett's X2) | 0.91 | 0.93 | 0.424 | 0.055 | 0.436 |

Vigour was significantly higher in nearly all plots which received post emergent nitrogen. Despite this significant increase in vigour, there was no significant yield difference between any of the treatments. The untreated control actually yielded the highest of all treatments at 1.70 t/ha although it did lack early vigour, as most other treatments exhibited stronger vigour when assessed approximately 14 WAS.

The lack of yield response to the addition of starter fertiliser would suggest sufficient background nutrition (primarily phosphorous) for the yields achieved for the growing season. Soil test data supports this, with Colwell P levels of 35-43 mg/kg measured across the trial site. Protein levels were reasonable across all treatments and there was no significant difference in hectolitre weights (i.e. in grain density). Screenings were all below receival standards and generally quite low, the exception being treatment 2 (NPK Crop B, microbes, 10.5 units N), at 4.26% screenings, which was significantly higher than most other treatments.

It is likely that seasonal conditions were a greater limiting factor to yield than any nutritional constraints. As evident by the yield of the untreated control, there was sufficient nitrogen and phosphorous supply to meet the demands of a 1.5 t/ha crop. Had growing season rainfall been greater, we may have expected to see more of a yield response to addition of fertiliser.

Last year's plots do not appear to have had a significant effect on the results of this year's trial. W.M.F. NPK plots which were sown on top of 2009 W.M.F. plots did not appear to be any better or worse than those plots which received high analysis fertiliser (treatments 5 and 6) for two consecutive seasons.

### Plant Tissue Data and Discussion

TABLE 16
Plant tissue analysis (samples taken 05/08/09) for all treatments

| | Treatment | | | | | | |
|---|---|---|---|---|---|---|---|
| | 1 | 2 | 3 | 4 | 5 | 6 | 7 |
| Nitrogen (%) | 4.06 | 4.54 | 4.39 | 3.84 | 3.91 | 4.27 | 3.8 |
| Phosphorous (%) | 0.34 | 0.34 | 0.33 | 0.29 | 0.39 | 0.39 | 0.38 |
| Potassium (%) | 3.10 | 3.27 | 3.16 | 3.13 | 3.65 | 3.65 | 3.50 |
| Sulphur (%) | 0.31 | 0.37 | 0.36 | 0.28 | 0.36 | 0.38 | 0.34 |
| Sodium (%) | 0.06 | 0.06 | 0.06 | 0.05 | 0.07 | 0.06 | 0.07 |
| Calcium (%) | 0.45 | 0.54 | 0.50 | 0.38 | 0.46 | 0.49 | 0.50 |
| Magnesium (%) | 0.18 | 0.21 | 0.20 | 0.16 | 0.19 | 0.21 | 0.21 |
| Chloride (%) | 1.33 | 1.10 | 1.22 | 1.28 | 1.41 | 1.21 | 1.24 |
| Copper (mg/kg) | 5.88 | 6.67 | 6.10 | 5.70 | 6.48 | 6.58 | 6.68 |
| Zinc (mg/kg) | 21.99 | 26.57 | 25.08 | 23.20 | 26.31 | 28.07 | 26.93 |
| Manganese | 111.8 | 106.9 | 110.7 | 106.9 | 131.9 | 117.9 | 145.9 |
| Iron (mg/kg) | 233.7 | 251.6 | 203.4 | 184.1 | 213.1 | 220.6 | 196.5 |
| Nitrate (mg/kg) | 75 | 129 | 114 | 111 | 85 | 74 | 47 |
| Boron (mg/kg) | 5.21 | 4.35 | 4.23 | 3.75 | 4.42 | 4.54 | 4.59 |

Nutrient levels were generally lower in the Untreated Control/No Fertiliser treatment (treatment 4). Phosphorus, sulphur, calcium, magnesium, copper, iron and boron levels were lower than in other treatments. Nitrate levels were varied but low for all treatments, however this was not expressed in yield or quality at the end of season.

### Meteorological Data

TABLE 17
Daily rainfall (111 m) for Graball, Bruce Rock Shire W. A. 2009 Station
Number: 010060. Latitude: 31.99°S. Longitude: 118.51°E. Elevation: 330 m. Graball
is the nearest station with complete rainfall records.

| | 2009 | | | | | | | | | | | |
|---|---|---|---|---|---|---|---|---|---|---|---|---|
| | January | February | March | April | May | June | July | August | September | October | November | December |
| 1 | 0 | 3.6 | 0 | 0 | 0 | 0 | 0 | 0 | 0 | 0 | 0 | 0 |
| 2 | 0 | 0 | 0 | 0 | 0 | 2.4 | 0 | 0 | 1.4 | 0 | 0 | 0 |
| 3 | 0 | 0 | 0 | 0 | 0 | 1.2 | 0 | 0 | 0 | 0 | 0 | 0 |
| 4 | 0 | 0 | 0 | 0 | 0 | 0 | 0 | 0 | 0 | 0 | 0 | 0 |
| 5 | 0 | 0 | 0 | 0 | 0 | 0 | 0 | 0 | 0 | 0 | 0 | 0 |
| 6 | 0 | 0 | 0 | 0 | 0 | 0 | 0 | 0 | 0.6 | 0 | 0 | 0 |
| 7 | 0 | 0 | 0 | 0 | 0 | 0 | 2.6 | 2.0 | 0 | 0 | 0 | 0 |
| 8 | 0 | 0 | 0 | 0 | 0 | 0 | 0 | 0 | 0 | 0 | 0 | 0 |
| 9 | 0 | 0 | 0 | 0 | 0 | 0 | 14.4 | 0.4 | 2.0 | 0 | 0 | 0 |
| 10 | 0 | 0 | 0 | 0 | 0 | 0 | 1.2 | 0 | 0.4 | 0 | 0 | 0 |
| 11 | 0 | 0 | 0 | 0 | 0 | 0 | 2.7 | 1.8 | 3.6 | 0 | 0 | 0 |
| 12 | 0 | 0 | 0 | 0 | 0 | 0 | 0 | 0 | 10.2 | 0 | 0 | 0 |
| 13 | 0 | 0 | 0 | 0 | 0 | 0 | 0 | 0 | 0 | 0 | 12.2 | 0 |
| 14 | 0 | 0 | 0 | 0 | 0 | 0 | 0 | 1.5 | 0 | 0 | 0 | 0 |
| 15 | 0 | 2.4 | 0 | 0 | 0 | 3.2 | 0 | 0 | 0 | 0 | 0 | 0 |
| 16 | 0 | 1.6 | 0 | 0 | 0 | 0 | 2.8 | 10.4 | 5.0 | 0 | 0 | 0 |
| 17 | 0 | 0 | 0 | 0 | 0 | 0 | 1.0 | 1.8 | 0 | 0 | 0 | 0 |
| 18 | 0 | 0 | 0 | 0 | 0 | 4.0 | 0 | 2.0 | 0 | 0 | 0 | 0 |
| 19 | 2.6 | 0 | 0 | 0 | 0 | 0 | 5.0 | 0 | 0 | 0 | 7.4 | 0 |
| 20 | 0 | 0 | 0 | 0 | 0 | 6.6 | 5.6 | 0 | 0 | 0 | 1.0 | 0 |
| 21 | 0 | 0 | 0 | 1.0 | 0 | 0 | 4.0 | 5.0 | 0 | 0 | 0 | 2 |
| 22 | 0 | 0 | 0 | 0 | 8.2 | 0 | 0 | 0 | 7.2 | 0 | 0 | 0 |
| 23 | 0 | 0 | 0 | 0 | 3.8 | 0 | 0 | 7.8 | 0 | 0 | 0 | 0 |
| 24 | 0 | 0 | 0 | 0 | 2.5 | 0.2 | 1.2 | 0 | 0 | 0 | 0 | 3 |
| 25 | 0 | 0 | 0 | 0 | 0 | 9.4 | 1.0 | 0 | 0 | 0 | 0 | 0 |
| 26 | 0 | 0 | 0 | 0 | 0 | 2.6 | 0 | 0 | 0 | 0 | 0 | 0 |
| 27 | 0 | 0 | 0 | 0 | 0 | 8.6 | 0 | 0 | 0 | 13.4 | 0 | 0 |
| 28 | 3.0 | 0 | 0 | 0. | 0 | 0 | 0 | 0 | 0 | 0 | 0 | 0 |
| 29 | 0 | | 0 | 0 | 0 | 1.8 | 0 | 8.6 | 4.2 | 0 | 0 | 0 |
| 30 | 0 | | 0 | 0 | 0 | 8.4 | 0 | 0 | 0.4 | 0 | 0 | 0 |
| 31 | 0 | | 0 | | 0 | | 0 | 0 | | 0 | | 0 |
| Highest | 3.0 | 3.6 | 0 | 1.0 | 8.2 | 9.4 | 14.4 | 10.4 | 10.2 | 13.4 | 12.2 | 3 |
| daily | | | | | | | | | | | | |
| Monthly | 5.6 | 7.6 | 0 | 1.0 | 14.5 | 48.4 | 41.5 | 41.3 | 35 | 13.4 | 20.6 | 5.0 |
| Total | | | | | | | | | | | | |
| Yearly | 233.9 | | | | | | | | | | | |
| Total | | | | | | | | | | | | |

### Soil Test Data

TABLE 18
Results of CSBP Comprehensive Soil Test Analysis for the
W.M.F. Bruce Rock trial site.

| | Western | Eastern | |
|---|---|---|---|
| Property | End Trial | End Trial | Average |
| Texture | 1.5 | 1.5 | — |
| Gravel (%) | 5 | 0 | — |
| Nitrate N (mg/kg) | 14 | 17 | 16 |
| Ammonium (g/kg) | 5 | 8 | 7 |
| Phosphorus (mg/kg) | 43 | 35 | 39 |
| Potassium (mg/kg) | 72 | 83 | 78 |
| Sulphur (mg/kg) | 12.9 | 9.8 | 11.4 |
| Organic Carbon (%) | 1.22 | 1.31 | 1.27 |
| Conductivity dS/m | 0.064 | 0.061 | 0.063 |
| pH (Calcium Chloride extraction) | 5.1 | 5.2 | 5.2 |
| pH (Water) | 5.9 | 6 | 6 |
| DTPA Copper (mg/kg) | 0.45 | 0.45 | 0.45 |
| DTPA Zinc (mg/kg) | 0.51 | 0.76 | 0.64 |
| DTPA Manganese (mg/kg) | 3.06 | 2.94 | 3 |
| DTPA Iron (mg/kg) | 75.22 | 70.79 | 73.01 |
| Exchangeable Calcium (meq/100 g) | 2.34 | 2.41 | 2.38 |
| Exchangeable Magnesium (meq/100 g) | 0.5 | 0.5 | 0.5 |
| Exchangeable Sodium (meq/100 g) | 0.08 | 0.06 | 0.07 |
| Exchangeable Potassium (meq/100 g) | 0.19 | 0.21 | 0.2 |
| Aluminium (mg/kg)-Calcium Chloride | 1.2 | 0.8 | 1.0 |
| Boron (mg/kg) | 0.5 | 0.5 | 0.5 |
| Exchangeable Aluminium (meq/100 g) | 0.11 | 0.1 | 0.11 |
| Total P (mg/kg) | 121 | 165 | 143 |
| Chloride (mg/kg) | 22 | 19 | 21 |

### Example 29

FIG. 37 shows results from the Department of Agriculture in W.A. The vertical axis represents dry matter from each lysimeter in grams, “F” indicates fertiliser (diammonium phosphate and Hydrocomplex) was applied, “no F” indicates that no fertiliser was applied, “COM” indicates that compost was applied at 25 tonnes/ha and BMC was applied at 3 tonnes per ha. The plants used in this experiment were rocket.

From the results it can be seen that addition of fertiliser improves the results compared with the corresponding case without fertiliser. Similarly, addition of biochar mineral complex improves the results compared with the corresponding case without biochar mineral complex. Use of biochar was of no benefit relative to the corresponding case with no additives, and indeed use of fertiliser alone showed better results than use of fertiliser with biochar. This demonstrates clearly that the biochar mineral complex of the present invention provides significant benefits relative to biochar.

1-56. (canceled)

57. A biochar-containing composition comprising:
(a) biochar having organic matter therein and/or thereon;
(b) clay intercalated with the organic matter; and
(c) at least one non-clay mineral.

58. The composition of claim 57 additionally comprising at least one plant growth promoter.

59. The composition of claim 58 wherein the at least one plant growth promoter is selected from the group consisting of: a nitrogen containing polymer, a butenolide, salicylic acid, small molecule oxygen and/or nitrogen functional growth promoters, chitin, chitosan and mixtures of any two or more thereof.

60. The composition of claim 57 wherein the at least one non-clay mineral is associated with the biochar or the clay or both.

61. The composition of claim 57 wherein either the biochar or the clay or both is intercalated with the at least one non-clay mineral.

62. The composition of claim 57 wherein the at least one non-clay mineral is selected from the group consisting of dolomite, rock phosphate, calcium, potassium and magnesium as their sulphate, chloride, oxide, hydroxide or carbonate salts, titanium containing minerals, sand, silica, silicates and rare earth metals and sulphate, oxide, hydroxide and carbonate salts thereof.

63. The composition of claim 56 wherein the organic matter is acid treated organic matter.

64. The composition of claim 56 which is in the form of particles and wherein at least some of the particles have a structure in which the biochar is surrounded by a layer comprising the clay and the non-clay minerals.

65. The composition of claim 56 in the form of a container.

66. A process for making a biochar-containing composition comprising:
(i) combining organic matter, one or more non-clay minerals, biochar and a swelling clay and mixing in a mixing vessel at a sufficient temperature for pillaring of the clay, so as to form a pillared mixture;
(ii) torrefying the pillared mixture in a torrefier so as to form a torrefied product and an exhaust gas, wherein a heated gas is injected into the torrefier during said torrefying; and
(iii) cooling the torrefied mixture to form the composition.

67. The process of claim 66 additionally comprising the step of combining the cooled torrefied mixture with at least one plant growth promoter.

68. The process of claim 66 wherein the biochar has been electroplated prior to step (i).

69. The process of claim 66 comprising the step of acid treating the organic matter prior to step (i).

70. The process of claim 66 comprising chemically oxidising the surface of the biochar prior to step (i).

71. A method for planting a crop in a soil comprising inserting seeds of said crop into the soil and locating a composition according to claim 57 near or in contact with the seeds.

72. An apparatus for making a biochar composition, comprising:
(a) a mixer for mixing starting materials at mildly elevated temperatures,
(b) torrefier for torrefying a pillared mixture produced in the mixer,
(c) a post-mixer for combining a torrefied product from the torrefier with additives, and
(d) a transfer device for transferring the mixture from the mixer to the torrefier, wherein the torrefier comprises at least one hot gas inlet port for passing a hot gas into the torrefier so as to heat contents of the torrefier in use.

73. The apparatus of claim 72 further comprising a biochar furnace or a substoichiometric combustor for producing biochar for use in the mixer, said furnace or combustor comprising an exhaust outlet coupled to the at least one hot gas inlet port of the torrefier so as to convey hot gases from the furnace or combustor to the torrefier in use.

74. The apparatus of claim 72 wherein:
the mixer comprises a heating jacket at least partially surrounding a mixing vessel for heating contents of the mixing vessel; and
the torrefier comprises a torrefier gas outlet in gas communication with THE heating jacket; whereby, in use, heated gas from the torrefier passes out of the torrefier gas outlet and into the heating jacket.

75. The apparatus of claim 74 wherein the heating jacket comprises a drain line coupled to the post-mixer whereby in use, condensate from the heated gas from the torrefier is conveyed to the post-mixer and combined with the torrefied product therein.

76. The apparatus of any one of claims 46 to 49 additionally comprising a pelletiser coupled to an outlet from the post-mixer for producing granules of the biochar composition from a mixture of the torrefied product and the additives.

77. A biochar-containing composition comprising:
(a) biochar having organic matter therein and/or thereon;
(b) clay associated with the organic matter; and
(c) at least one non-clay mineral.
